(19) United States
(12) Patent Application Publication
(10) Pub. No.: US 2006/0257129 A1
(43) Pub. Date: Nov. 16, 2006

(54) Image sensing apparatus equipped with anti-shake mechanism

(75) Inventor: Kazuhiro Shibatani, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/405,658

(22) Filed: Apr. 17, 2006

(30) Foreign Application Priority Data
May 11, 2005 (JP) 2005-138492

(51) Int. Cl. G03B 17/00

(52) U.S. Cl. 396/55

(57) ABSTRACT

An image sensing apparatus is equipped with an anti-shake mechanism. A shake amount of a main body of the image sensing apparatus is detected, and an anti-shake drive signal is generated in accordance with a detected shake amount. The anti-shake drive signal is sent to a plurality of actuators to apply an anti-shake driving force to a driven member provided in an imaging optical system of the image sensing apparatus at different positions from each other. A control axis about which the driven member is driven for anti-shake control extends in a direction different from a drive axis along which the driven member is driven for actual movement.

This application is based on Japanese Patent Application No. 2005-138492 filed on May 11, 2005, the contents of which are hereby incorporated by reference.

### BACKGROUND OF THE INVENTION

1. Field of the Invention

The present invention relates to an image sensing apparatus equipped with an anti-shake mechanism in an imaging optical system, such as a digital camera or a camera phone.

2. Description of the Related Art

Various anti-shake mechanisms are adopted in image sensing apparatuses such as digital cameras in order to suppress photographic failure due to shake of the image sensing apparatuses. As examples of the conventional anti-shake mechanisms, various techniques such as pivotally supporting a lens barrel with use of a so-called gimbal mechanism, correctively shifting an anti-shake lens in a lens barrel on a plane perpendicular to an optical axis in such a direction as to cancel a shake of a camera, and correctively shifting a solid-state image sensor such as a CCD sensor on a plane perpendicular to an optical axis have been put into practice.

Also, as shown in FIG. 24, for instance, there is proposed an approach of driving a lens barrel for anti-shake control without using a gimbal mechanism. Specifically, the publication discloses an anti-shake mechanism 90, wherein a lens barrel 91 is one-point supported by a ball bearing 92, and a motion restrainer 94 is provided to restrain unnecessary movement of the lens barrel 91. Two actuators 93A, 93B are arranged to apply anti-shake driving forces to the lens barrel 91 at different positions from each other so that the lens barrel 91 is driven for anti-shake control, in other words, the lens barrel 91 is rotated by the actuators 93A, 93B while being supported by the ball bearing 92 in accordance with detection values outputted from gyro sensors 95A, 95B which detect rotated amounts of a camera body about A-axis corresponding to pitch direction, and about B-axis corresponding to yaw direction, respectively. The A-axis and the B-axis are orthogonal to each other. The anti-shake mechanism 90 can be miniaturized, as compared with a gimbal mechanism, and is suitable as an anti-shake mechanism for a lens barrel provided in a compact digital camera or a like device.

In the anti-shake mechanism 90, shake detection axes about which the rotated amounts of the camera body are detected by the gyro sensors 95A, 95B i.e. A-axis, B-axis, and anti-shake control axes of the lens barrel 91 about which the lens barrel 91 is rotated for anti-shake control are made coincident with each other, respectively. Also, the anti-shake control axes for the lens barrel 91 i.e. the A-axis, the B-axis, and drive axes along which the lens barrel 91 is to be actually moved or shifted by the actuators 93A, 93B are made coincident with each other, respectively. Specifically, an anti-shake driving force for driving the lens barrel 91 about the A-axis in the pitch direction while supporting the lens barrel 91 by the ball bearing 92 is applied exclusively by the actuator 93A, and an anti-shake driving force for driving the lens barrel 91 about the B-axis in the yaw direction while supporting the lens barrel 91 by the ball bearing 92 is applied exclusively by the actuator 93B. In other words, the actuators 93A, 93B are designed to correct rotated amounts of the camera body about the A-axis and the B-axis independently of each other. The motion restrainer 94 is adapted to restrain rotation of the lens barrel 91 in clockwise and counterclockwise directions about the support point, namely, in vertical directions on the plane of FIG. 24.

The anti-shake mechanisms disclosed in the conventional art failed to provide measures on miniaturization of the anti-shake mechanism itself or the actuators for performing anti-shake driving, as well as an energy saving measure. Also, it cannot be said that the anti-shake mechanism 90 as shown in FIG. 24 provides sufficient measures on miniaturization of the actuators and energy saving for the following reason.

FIG. 25 is an illustration for describing the anti-shake driving by the anti-shake mechanism 90. Assuming that the distance between the point of application of force for driving the lens barrel 91 by the actuator 93A, and the A-axis, which is an anti-shake control axis for the lens barrel 91 in the pitch direction is defined as IA, and the distance between the point of application of force for driving the lens barrel 91 by the actuator 93B, and the B-axis, which is an anti-shake control axis for the lens barrel 91 in the yaw direction is defined as IB, and assuming that thrusts of the actuators 93A, 93B are defined as FA, FB, respectively, then, torques NA, NB necessary for rotating the lens barrel 91 about the A-axis or the B-axis by controlling the actuators 93A, 93B to drive the lens barrel 91 for anti-shake control are expressed by the following equations (1), (2), respectively.
NA=IA×FA (1)
NB=IB×FB (2)

As mentioned above, the anti-shake mechanism 90 is constructed in such a manner that the actuator 93A drives the lens barrel 91 about the A-axis, and the actuator 93B drives the lens barrel 91 about the B-axis, respectively, independently of each other. In other words, as shown in FIG. 26, the anti-shake driving control about the A-axis and the B-axis by the respective actuators 93A and 93B is conducted every predetermined sampling interval. In view of this, it is required to set the torques NA, NB expressed by the equations (1), (2) to such large amounts capable of rotating the lens barrel 91 with a single actuator. In the case where a stepping motor is used as the actuator, use of the stepping motors each capable of providing the large torques NA, NB is necessary.

Also, in the case where an electromagnetic actuator such as a moving coil is used as the actuator, constant energization is required while the anti-shake mechanism is in operation, irrespective of an actual driving state of the actuator to drive the lens barrel 91 for anti-shake control. It is seldom likely that the anti-shake driving operations of the lens barrel 91 about the A-axis and the B-axis are performed substantially equally at each sampling interval. For instance, when the actuator 93A is driven for anti-shake control of the lens barrel 91 about the A-axis, an electric power may be consumed for the actuator 93B as well as for the actuator 93A despite likelihood that the actuator 93B may not substantially work, which deteriorates the power efficiency.

As mentioned above, the anti-shake mechanism 90 has suffered from the disadvantages such as increase of the size of the actuators for driving the lens barrel for anti-shake control or waste of an electric power.

### SUMMARY OF THE INVENTION

In view of the above problems residing in the prior art, it is an object of the present invention to provide an anti-shake-mechanism-equipped image sensing apparatus that enables to miniaturize an actuator while attaining energy saving to thereby miniaturize the image sensing apparatus while attaining energy saving.

According to an aspect of the invention, an image sensing apparatus is equipped with an anti-shake mechanism. A shake amount of a main body of the image sensing apparatus is detected, and an anti-shake drive signal is generated in accordance with a detected shake amount. The anti-shake drive signal is sent to a plurality of actuators to apply an anti-shake driving force to a driven member provided in an imaging optical system of the image sensing apparatus at different positions from each other. A control axis about which the driven member is driven for anti-shake control by the actuators extends in a direction different from a drive axis along which the driven member is actually moved by the actuators

These and other objects, features and advantages of the present invention will become more apparent upon reading of the following detailed description along with the accompanying drawings.

### BRIEF DESCRIPTION OF THE DRAWINGS

FIGS. 1A and 1B are illustrations showing an external appearance of a digital camera according to an embodiment of the invention, wherein FIG. 1A is a front view, and FIG. 1B is a rear view.

FIG. 2 is a cross-sectional view showing a collapsible lens barrel as a driven member.

FIG. 3 is a block diagram schematically showing essential parts of an electrical configuration of the digital camera in the embodiment.

FIG. 4 is a functional block diagram showing a function of a controlling circuit shown in FIG. 3.

FIG. 5 is a time chart showing drive pulses to be generated by the controlling circuit.

FIG. 6 is an illustration schematically showing an arrangement of a first anti-shake mechanism in accordance with the embodiment.

FIG. 7 is an exploded perspective view showing essential parts of the first anti-shake mechanism.

FIG. 8 is an illustration showing a relation between anti-shake axes and drive axes of actuators in the first anti-shake mechanism.

FIG. 9 is a control block diagram of the first anti-shake mechanism.

FIG. 10A is a time chart showing control operations to be executed by the first anti-shake mechanism at each sampling interval.

FIG. 10B is an illustration showing a relation between target position and follow-up track for anti-shake control.

FIG. 11 is a control block diagram showing a modification of the first anti-shake mechanism.

FIG. 12 is a time chart showing control operations to be executed by the first anti-shake mechanism at each sampling interval based on the control block diagram shown in FIG. 11.

FIG. 13 is an illustration schematically showing a second anti-shake mechanism in accordance with the embodiment of the invention.

FIG. 14 is an illustration showing a relation between anti-shake axes and drive axes of actuators in the second anti-shake mechanism.

FIG. 15 is a control block diagram of the second anti-shake mechanism.

FIG. 16 is a time chart showing control operations to be executed by the second anti-shake mechanism at each sampling interval.

FIG. 17 is an illustration showing a schematic arrangement of a third anti-shake mechanism in accordance with the embodiment of the invention, as well a relation between anti-shake axes and drive axes of actuators.

FIG. 18 is a control block diagram of the third anti-shake mechanism.

FIG. 19 is an illustration showing a schematic arrangement of a fourth anti-shake mechanism in accordance with the embodiment of the invention, as well as a relation between anti-shake axes and drive axes of actuators.

FIG. 20 is a control block diagram of the fourth anti-shake mechanism.

FIG. 21 is an illustration showing a schematic arrangement of a fifth anti-shake mechanism in accordance with the embodiment of the invention, as well as a relation between anti-shake axes and drive axes of actuators.

FIG. 22 is a control block diagram of the fifth anti-shake mechanism.

FIG. 23 is an illustration schematically showing an arrangement of a sixth anti-shake mechanism in accordance with the embodiment of the invention.

FIG. 24 is an illustration briefly showing a conventional anti-shake mechanism.

FIG. 25 is an illustration showing a relation between anti-shake axes and drive axes of actuators in the conventional anti-shake mechanism.

FIG. 26 is a time chart showing control operations to be executed by the conventional anti-shake mechanism at each sampling interval.

### DETAILED DESCRIPTION OF THE PREFERRED EMBODIMENTS OF THE INVENTION

In the following, an anti-shake-mechanism-equipped image sensing apparatus embodying the invention is described in details based on an example of a lens-barrel-built-in digital camera.

(Description on Camera Construction)

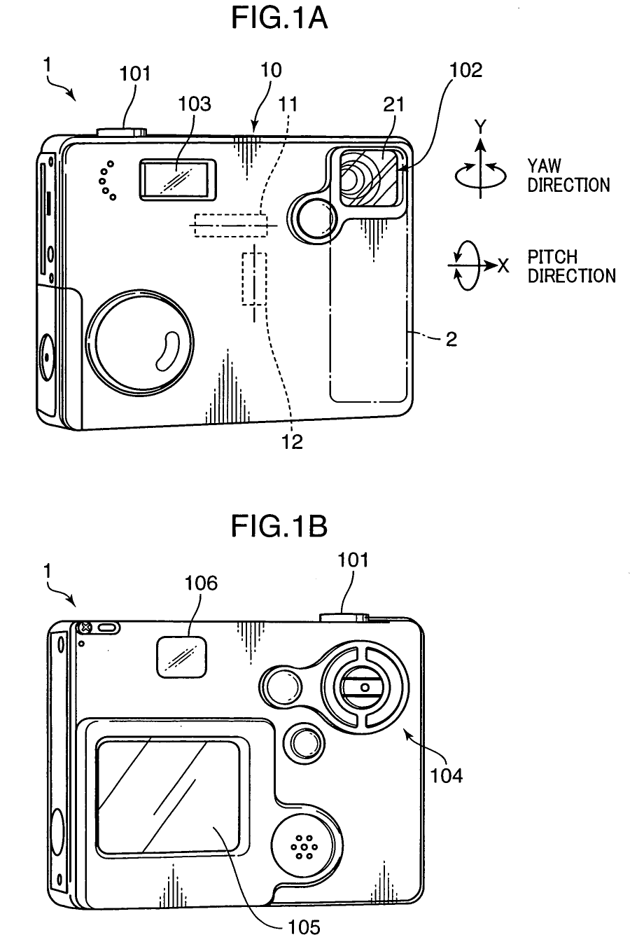

FIGS. 1A and 1B are illustrations showing an external appearance of the digital camera 1 embodying the invention. FIG. 1A is a front view, and FIG. 1B is a rear view. The lens-barrel-built-in digital camera 1 has a camera body 10. A shutter release button 101 and the like are provided on a top part of the camera body 10, a photographing window 102, a flash section 103 and the like are provided on a front part thereof, and various operation buttons 104, a display section 105 including a liquid crystal display (LCD) monitor, a viewfinder section 106, and the like are provided on a rear part thereof.

A collapsible lens barrel 2, which serves as an imaging optical system or a driven member, and constitutes a photographic lens system for receiving a subject image through an objective lens 21 by way of the photographing window 102 to guide the subject image onto a solid-state image sensor in the camera body 10, is provided in the camera body 10. The collapsible lens barrel 2 is a lens barrel with its length being fixed, in other words, does not protrude outside of the camera body 10 during its operation such as zooming or focusing driving. The solid-state image sensor is integrally mounted on an imaging side of the lens barrel 2. Also, a pitch gyro sensor 11 for detecting a shake of the camera body 10 in a pitch direction and a yaw gyro sensor 12 for detecting a shake of the camera body 10 in a yaw direction are provided in the camera body 10. The pitch gyro sensor 11 and the yaw gyro sensor 12 serve as a shake detector for detecting a shake amount of the camera 1. In the specification and the claims, a horizontal direction or transverse direction of the camera 1 is defined as X-axis direction, a vertical direction or height direction of the camera 1 is defined as Y-axis direction, a rotating direction of the camera 1 about the X-axis is defined as pitch direction, and a rotating direction of the camera 1 about the Y-axis is defined as yaw direction.

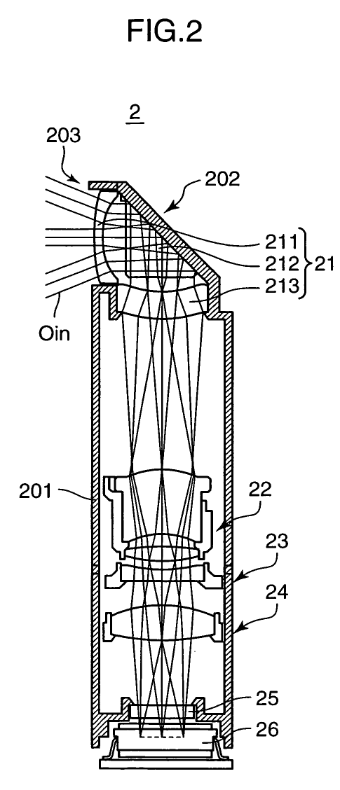

FIG. 2 is a cross-sectional view exemplarily showing an internal construction of the collapsible lens barrel 2 at a wide-angle position. The collapsible lens barrel 2 has such a cylindrical shape as to be housed in the camera body 10 in a vertical position or a horizontal position. The lens barrel 2 has a cylindrical portion 201 for accommodating a lens group therein, and a bent portion 202, which is arranged at such a position as opposed to the photographing window 102 and is formed with an opening 203 for allowing a subject image to be incident into the lens barrel 2.

An objective lens group comprised of a first lens element 211 fixed to the opening 203, a prism 212 mounted on a slope of the bent portion 202, and a second lens element 213 arranged near an inlet of the cylindrical portion 201 is fixedly provided on the bent portion 202. Also, a first zoom lens block 22, a fixed lens block 23, and a second zoom lens block 24 are arranged in series along an optical axis of the lens barrel 2 inside the cylindrical portion 201. The solid-state image sensor 26 e.g. a CCD sensor is fixedly mounted near an outlet of the cylindrical portion 201 by way of a low-pass filter 25 having a moire suppressing effect. Specifically, when the lens barrel 2 is rotated, the solid-state image sensor 26 is rotated integrally with the lens barrel 2. Then, a light flux Oin representing the subject image is incident through the opening 203 while being bent by 90° through the prism 212 of the objective lens group 21, and is guided onto a light receiving plane of the solid-state image sensor 26 via the first zoom lens block 22, the fixed lens block 23, the second zoom lens block 24, and the low-pass filter 25.

The collapsible lens barrel 2 built in the camera body 10 has such an arrangement that an anti-shake driving force is applied to the lens barrel 2 by actuators, which will be described later. Specifically, in the case where a shake of the camera body 10 is detected by the pitch gyro sensor 11 and the yaw gyro sensor 12, the lens barrel 2 is subjected to driving forces in drive axis directions by the actuators, thereby being drivingly rotated or drivingly rotated about predetermined anti-shake control axes e.g. in the pitch direction and in the yaw direction in order to cancel the shake. The arrangement and the drive axes of the actuators, and the anti-shake control axes will be described later in detail.

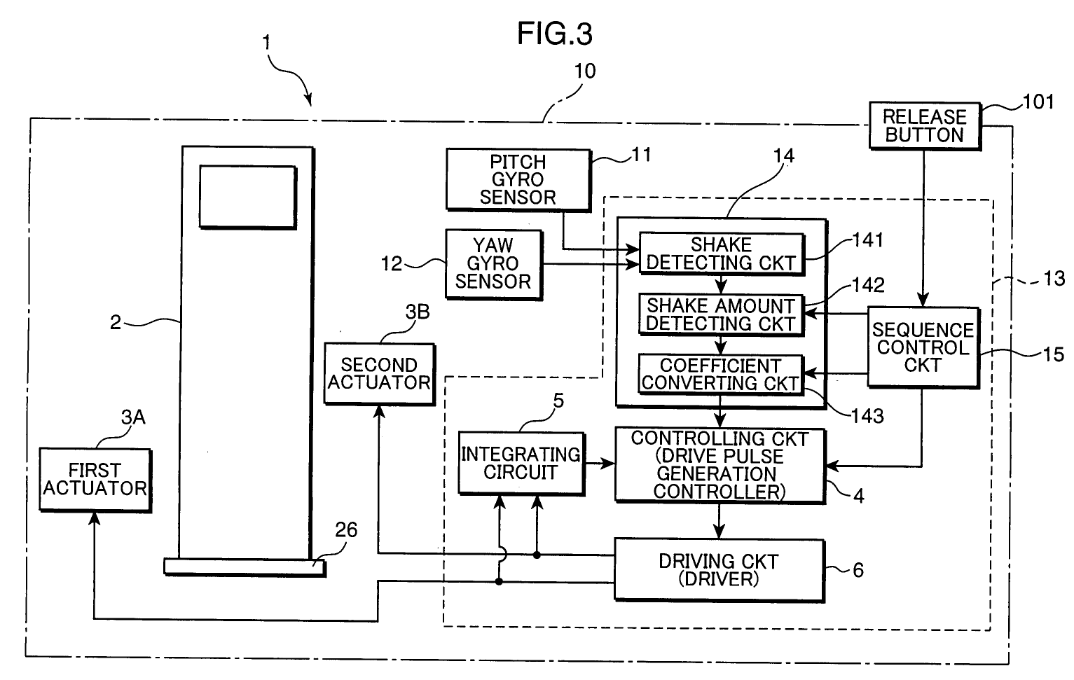

FIG. 3 is a block diagram schematically showing essential parts of an electrical configuration of the digital camera 1 in the embodiment. The camera body 10 of the digital camera 1 is internally provided with the release button 101, the pitch gyro sensor 11 and the yaw gyro sensor 12 serving as an anti-shake detector for detecting a shake of the digital camera 1, a circuit section 13 provided with various circuit substrate blocks, the lens barrel 2 constituting an imaging optical system, and a first actuator 3A and a second actuator 3B constituted of stepping motors for driving the lens barrel 2 for anti-shake control. Also, the circuit section 13 includes a target position computing section 14, a sequence control circuit 15, a controlling circuit 4, an integrating circuit 5, and a driving circuit 6. Embodiments, which will be described later, are made on a premise that two through four actuators are used. In the following, an example of using two actuators is described.

The release button 101 is an operation switch. A user is allowed to perform a photographing operation by depressing the release button 101. When the release button 101 is brought to a halfway-pressed state, the digital camera 1 enters a photographing preparatory condition. When the digital camera 1 enters the photographing preparatory condition, auto-focusing (AF) control for automatically focusing a subject image, an automatic exposure (AE) control for automatically determining an exposure, and an anti-shake function of canceling a photographic failure due to shake of the digital camera 1 are operated. The anti-shake function is sequentially operated while the release button 101 is depressed to facilitate a framing operation. Also, when the release button 101 is brought to a fully-pressed state by user's manipulation, a photographing operation is conducted. Specifically, an exposure control is conducted in accordance with the exposure state determined by the AE control so that an optimal exposure is obtained for the solid-state image sensor 26.

The pitch gyro sensor 11 is a gyro sensor for detecting a shake of the digital camera 1 in the pitch direction (see FIG. 1). The yaw gyro sensor 12 is a gyro sensor for detecting a shake of the digital camera 1 in the yaw direction (see FIG. 1). The gyro sensor used in the embodiment is adapted to detect an angular velocity of a shake of an object to be measured i.e. the camera body 10 in the embodiment in the case where the camera body 10 is swung due to the shake applied thereto. The gyro sensor may detect the angular velocity of the shake by, for instance, applying a certain voltage to a piezoelectric device to rotate the piezoelectric device, and by extracting a distortion arising from Coriolis action that is generated when the angular velocity due to swing of the camera body 10 is applied to the rotating piezoelectric device, as an electric signal.

The target position computing section 14 generates control target information which is defined at a predetermined sampling frequency. Specifically, the target position computing section 14 is operative to acquire a pitch angular velocity signal detected by the pitch gyro sensor 11 and a yaw angular velocity signal detected by the yaw gyro sensor 12 to define a control target value for servo control i.e. target position information of the lens barrel 2 as the driven member. The target position computing section 14 includes a shake detecting circuit 141, a shake amount detecting circuit 142, and a coefficient converting circuit 143.

The shake detecting circuit 141 includes processing circuits such as filter circuits i.e. a low-pass filter and a high-pass filter for suppressing noise and drift in the angular velocity signals detected by the pitch gyro sensor 11 and the yaw gyro sensor 12, and amplifying circuits for amplifying the angular velocity signals, respectively. The angular velocity signals that have undergone the processing by the processing circuits are outputted to the shake amount detecting circuit 142.

The shake amount detecting circuit 142 detects the processed angular velocity signals at a predetermined time interval, and performs integration processing for the detected angular velocity signals to output, to the coefficient converting circuit 143, the processed angular velocity signals as an angular signal θx representing a shake amount of the digital camera 1 in the X-axis direction, and an angular signal θy representing a shake amount of the digital camera 1 in the Y-axis direction. In the case where shake detection axes x, y of the pitch gyro sensor 11 and the yaw gyro sensor 12, and anti-shake control axes xa, ya (hereinafter, simply called as “anti-shake axes”) for the lens barrel 2 are made coincident with each other, the angular signals θx, θy are used. In the case where the anti-shake axes xa, ya are defined in different directions from the shake detection axes x, y, the angular signals θx, θy are converted into angular signals θxa, θya about the anti-shake axes xa, ya, and the angular signals θxa, θya are outputted to the coefficient converting circuit 143.

The coefficient converting circuit 143 converts the shake amounts i.e. the angular signals θx, θy or θxa, θya representing a shake of the camera body 10 in the X-axis direction and the Y-axis direction, which have been outputted from the shake amount detecting circuit 142, into a shift amount (px, py) in the respective directions i.e. a positioning target value by which the lens barrel 2 is to be rotated about the anti-shake axes by the first actuator 3A and the second actuator 3B. The positioning target value is obtained by multiplying angular data corresponding to the angular signals θx, θy or θxa, θya about the anti-shake axes i.e. a first control axis and a second control axis, which correspond to the shake detection axes of the pitch gyro sensor 11 and the yaw gyro sensor 12 in the pitch direction and the yaw direction, by the respective distances between the first control axis (or the second control axis), and points of application of force on the lens barrel 2 by the first actuator 3A and the second actuator 3B. A signal indicating the shift amount (px, py) in the respective directions, which has been outputted from the coefficient converting circuit 143, is outputted to the controlling circuit 4.

The controlling circuit 4, serving as a drive pulse generation controller, controllably generates a drive pulse for driving the first actuator 3A and the second actuator 3B constituted of the stepping motors. The controlling circuit 4 converts the signal indicating the shift amount (px, py) in the respective directions into a drive pulse signal for actually driving the first actuator 3A and the second actuator 3B, considering position information sent from the integrating circuit 5, which will be described later, operation characteristics of the first actuator 3A and the second actuator 3B, and the like. Specifically, the controlling circuit 4 functions as a computing section for computing requirements on drive pulse generation, which is required for the lens barrel 2 to correctively rotate to attain the aforementioned control target value so that anti-shake control i.e. servo control to attain the control target value outputted from the target position computing section 14 is executed based on the detection signals from the pitch gyro sensor 11 and the yaw gyro sensor 12. The function of the controlling circuit 4 will be described later in detail.

The integrating circuit 5 is provided to control the first actuator 3A and the second actuator 3B in an open-loop manner. The integrating circuit 5 integrates the number of drive pulses generated by the driving circuit 6 to be described later, generates current position information of the stepping motors i.e. rotary position information of the lens barrel 2 for output to the controlling circuit 4. In the case where a closed-loop control is adopted, a position sensor, and a converting circuit for converting sensing information outputted from the position sensor into position information are provided in place of the integrating circuit 5.

The driving circuit 6 has a pulse generation circuit, and generates drive pulses for actually driving the first actuator 3A and the second actuator 3B. The drive pulses are generated based on a drive pulse generation control signal outputted from the controlling circuit 4.

The operations of the shake amount detecting circuit 142, the coefficient converting circuit 143, and the controlling circuit 4 are controlled by the sequence control circuit 15. Specifically, in response to depressing of the release button 101, the sequence control circuit 15 controls the shake amount detecting circuit 142 to read out data signals relating to the shake amounts in the X-axis direction and the Y-axis direction i.e. the aforementioned angular signals θx, θy or θxa, θya. Then, the sequence control circuit 15 controls the coefficient converting circuit 143 to convert the shake amounts in the respective directions into the shift amount (px, py) in the respective directions. Thereafter, the sequence control circuit 15 controls the controlling circuit 4 to calculate a corrective driving amount for the lens barrel 2 based on the shift amount (px, py) in the respective directions at a predetermined sampling frequency. These operations are cyclically repeated at a predetermined time interval during a period from the point of time when the release button 101 is brought to a fully-pressed state until an exposure is completed for rotating the lens barrel 2 for anti-shake control.

The stepping motor constituting the first actuator 3A or the second actuator 3B may be a commercially available compact stepping motor equipped with a stator core and a rotor core. It is desirable to directly connect a rotary screw shaft to the rotor core so as to directly drive the lens barrel 2 for anti-shake control, and to mount a movable member such as a nut on the rotary screw shaft. Alternatively, a linear stepping motor having an arrangement that a rotor is linearly moved relative to a stator may be used in place of the rotary stepping motor.

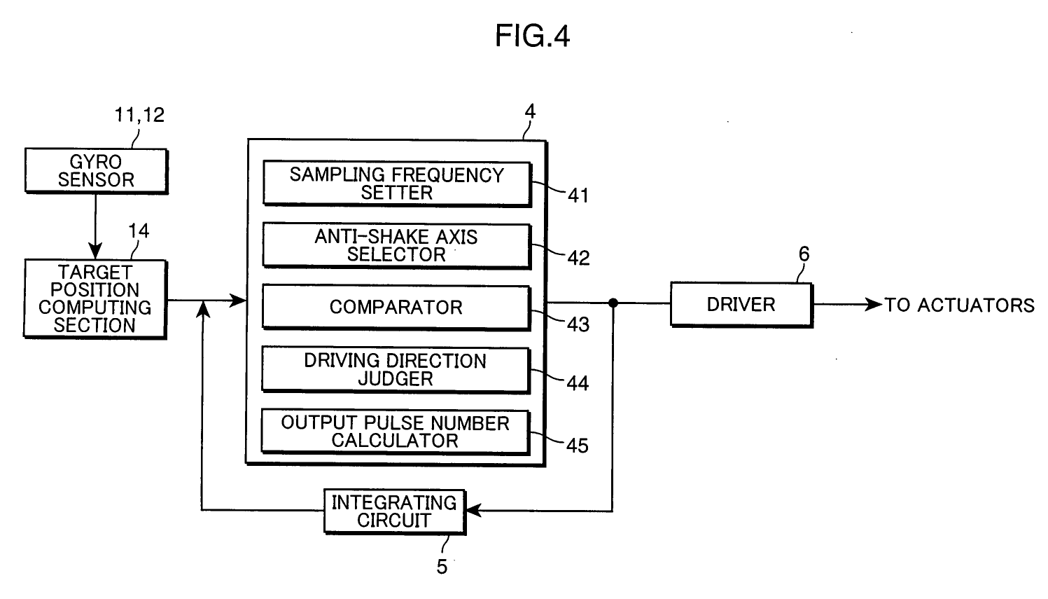

FIG. 4 is a functional block diagram for describing a function of the controlling circuit 4. A primary function of the controlling circuit 4 is to define requirements on pulse drive generation for driving the first actuator 3A and the second actuator 3B at a predetermined sampling frequency. The controlling circuit 4 includes a sampling frequency setter 41, an anti-shake axis selector 42, a comparator 43, a driving direction judger 44, and an output pulse number calculator 45.

The sampling frequency setter 41 accepts setting on a sampling frequency at which a control target value for servo control is to be acquired from the target position computing section 14. The sampling frequency can be arbitrarily set from a range of about 0.1 ms to 2 ms, for instance. Generally, shortening the sampling frequency enables to acquire a control target value within a short period, which provides improved follow-up performance. A proper sampling frequency may be set considering the computing performance of the controlling circuit 4 or performance of the stepping motor.

The anti-shake axis selector 42 time-shares a sampling interval of the sampling frequency set by the sampling frequency setter 41, and acquires, from the target position computing section 14, target position information i.e. a signal indicating the shift amount (px, py) for servo control for each of the anti-shake axes. For instance, in the case where the anti-shake axes are defined as a first control axis and a second control axis which extend in different directions from each other, the anti-shake axis selector 42 performs a switching operation so that a signal indicating a shift amount for anti-shake driving about the first control axis is read out in the former half period of the sampling interval, and that a signal indicating a shift amount for anti-shake driving about the second control axis is read out in the latter half period of the sampling interval.

The comparator 43 compares current position information of the rotor of each stepping motor i.e. the first actuator 3A and the second actuator 3B, in other words, rotary position information of the lens barrel 2, which is a signal indicative of an integrated value outputted from the integrating circuit 5, with the acquired target position information to obtain a position deviation e between the current position information and the target position information. The lens barrel 2 is drivingly rotated about the respective anti-shake axes by the first actuator 3A and the second actuator 3B so that the position deviation e becomes close to zero as much as possible.

The driving direction judger 44 judges the direction about which the stepping motor is to be rotated, based on a judgment as to whether the position deviation e obtained by the comparator 43 is plus or minus. The driving direction judger 44 generates a control signal for changing the order of applying a current to a stator coil to rotate the rotor in forward direction or backward direction, based on the judgment result on the rotating direction of the stepping motor.

The output pulse number calculator 45 resets the requirements on drive pulse generation at a predetermined sampling frequency based on the position deviation e obtained by the comparator 43, and performs computation to define the requirements on drive pulse generation i.e. the number of drive pulses to be generated within a sampling interval until the next sampling frequency. Specifically, the output pulse number calculator 45 calculates the number of drive pulses for controlling the stepping motors to execute driving about the respective anti-shake axes, based on the shift amounts (px, py) about the respective anti-shake axes, which have been acquired by the anti-shake axis selector 42.

The control signal concerning the forward rotation or the backward rotation of the rotor which has been generated by the driving direction judger 44, and the control signal concerning the drive pulse number which has been generated by the output pulse number calculator 45 are outputted to the driving circuit 6, which, in turn, in response to the control signals, causes the pulse generation circuit to generate predetermined drive pulses so as to drive the first actuator 3A and the second actuator 3B.

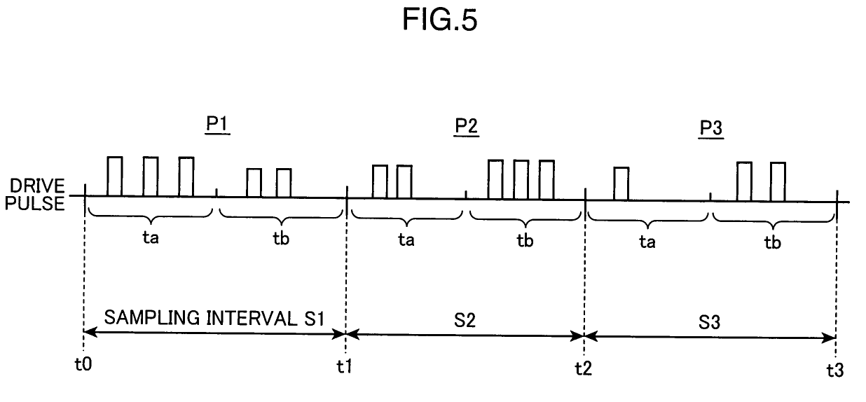

FIG. 5 is a time chart for illustrating an example of drive pulses to be generated by the controlling circuit 4. As shown in FIG. 5, a sampling interval is time-shared by a period ta during which anti-shake driving about the first control axis is performed, and a period tb during which anti-shake driving about the second control axis is performed, and the number of drive pulses required for the anti-shake driving about the first and second control axes is outputted during the respective periods ta, tb. The number of drive pulses to be generated within each sampling interval is determined depending on a required maximal driving speed of the actuators, and resolution performance on positioning. Since an excessively small drive pulse rate may cause loss of synchronization, an adequate pulse rate free of loss of synchronization is selected.

The requirements on drive pulse generation are reset at each sampling frequency, and new requirements on drive pulse generation are defined at each sampling interval. Specifically, in the case where a certain drive pulse train P1 is outputted in a first sampling interval S1, the requirements on generation of the drive pulse train P1 is reset at a first sampling frequency t1, and requirements on a drive pulse train P2 which is to be generated within a next sampling interval i.e. a second sampling interval S2 are defined by the controlling circuit 4. In the similar manner as mentioned above, the requirements on generation of the drive pulse train P2 is reset at a second sampling frequency t2, and requirements on a drive pulse train P3 to be generated within a third sampling interval S3 are defined. The above drive pulse control enables to simultaneously drive the first actuator 3A and the second actuator 3B, and to execute anti-shake driving about the first control axis and the second control axis by the first actuator 3A and the second actuator 3B in cooperation with each other.

(Description on Various Anti-shake Mechanisms)

Various anti-shake mechanisms mountable to the digital camera 1 having the above basic arrangement are described one by one.

<First Anti-Shake Mechanism>

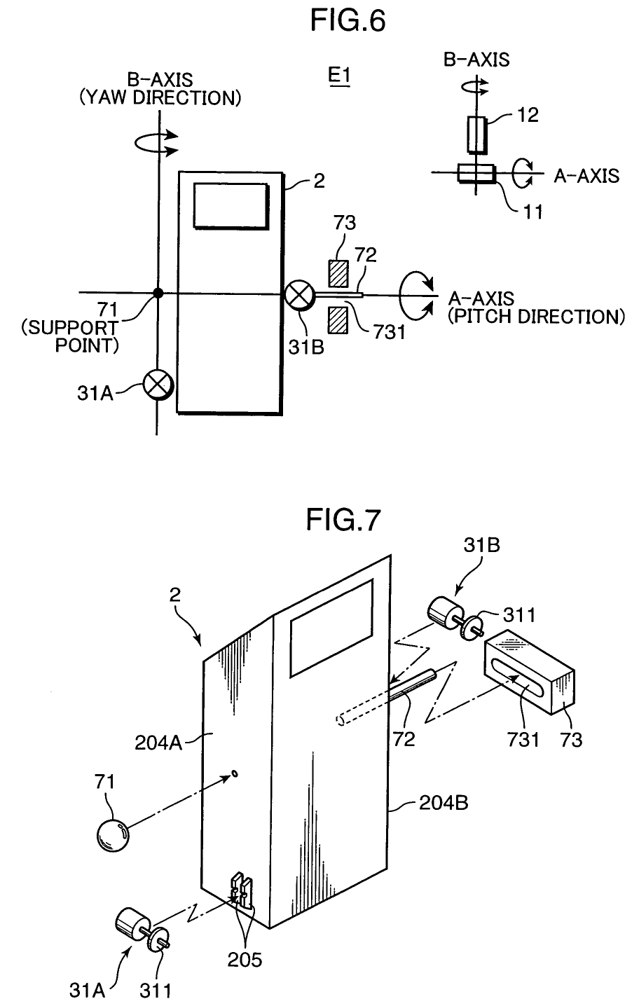

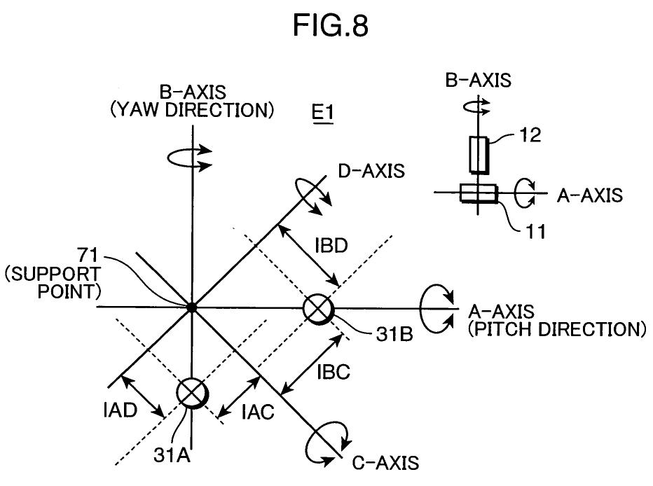

FIG. 6 is an illustration briefly showing an arrangement of an anti-shake mechanism E1 in accordance with the embodiment. FIG. 7 is an exploded perspective view of the first anti-shake mechanism E1. FIG. 8 is an illustration showing a relation between anti-shake axes and drive axes of actuators in the anti-shake mechanism E1. The anti-shake mechanism E1 includes a lens barrel 2, a ball bearing 71 as a support member for supporting the lens barrel 2 at one point, a first actuator 31A and a second actuator 31B for applying anti-shake driving forces to the lens barrel 2 at different positions from each other, and a motion restrainer 73.

As shown in FIG. 7, the ball bearing 71 is arranged at a substantially middle position on a side wall 204A of the lens barrel 2 in contact therewith. This arrangement allows the lens barrel 2 to be rotated about A-axis corresponding to pitch direction, and B-axis corresponding to yaw direction (see FIG. 6), while being supported by the ball bearing 71. The first actuator 31A has a stepping motor, and is mounted at a lower position on the side wall 204A of the lens barrel 2. The first actuator 31A has a movable member 311 mounted on a rotary screw shaft thereof so that forward and backward movements of the movable member 311 are restrained by a pair of intervening pieces 205 projecting from the side wall 204A. Specifically, the movable member 311 is received in a space defined by the intervening pieces 205, and the intervening piece pair 205 acts as a point of application of force for the lens barrel 2 each time the movable member 311 is moved forward or backward in response to driving of the first actuator 31A. The drive axis of the actuator corresponds to an axis of the rotary screw shaft of the actuator (see FIG. 7).

Similarly to the first actuator 31A, the second actuator 31B has a stepping motor and a movable member 311. The movable member 311 of the second actuator 31B is mounted at such a position that forward and backward movements of the movable member 311 are restrained by an unillustrated pair of intervening pieces 205 projecting from a side wall 204B opposite to the side wall 204A where the ball bearing 71 is mounted. The second actuator 31B is arranged at a substantially vertically middle position on the side wall 204B. In other words, the second actuator 31B and the first actuator 31A are mounted at such positions that the points of application of force for the lens barrel 2 are respectively defined at a position that passes the support point of the lens barrel 2 and is located on the A-axis, and at a position that passes the support point and is located on the B-axis extending orthogonal to the A-axis.

The motion restrainer 73 is provided near the side wall 204B. The motion restrainer 73 has a guide slit 731 extending in the optical axis direction. A guide pin 72 extending through the side wall 204B passes through the guide slit 731. With this arrangement, vertical movements of the lens barrel 2 relative to the support point of the lens barrel 2 on the plane of FIG. 6 are restricted, yet rotation of the lens barrel 2 about the A-axis, where the guide pin 72 is rotated clockwise and counterclockwise within the guide slit 731, and rotation of the lens barrel 2 about the B-axis, where the guide pin 72 slides transversely within the guide slit 731 are allowed, while being supported by the support point defined by the ball bearing 71.

The drive axis of the first actuator 31A along which the lens barrel 2 is driven corresponds to the A-axis direction i.e. pitch direction. Specifically, as the movable member 311 of the first actuator 31A moves forward and backward, a rotating force about the A-axis is exerted to the lens barrel 2, while the lens barrel 2 is supported by the ball bearing 71 (see FIG. 6). Also, the drive axis of the second actuator 31B along which the lens barrel 2 is driven corresponds to the B-axis direction i.e. yaw direction. Specifically, as the movable member 311 of the second actuator 31B moves forward and backward, a rotating force about the B-axis is exerted to the lens barrel 2, while the lens barrel 2 is supported by the ball bearing 71 (see FIG. 6). The A-axis and the B-axis coincide with shake detection axes of the pitch gyro sensor 11 and the yaw gyro sensor 12, respectively.

The hardware construction of the anti-shake mechanism E1 is substantially identical to the conventional anti-shake mechanism 90 shown in FIG. 24 except for the following. In the anti-shake mechanism E1, anti-shake axes for the lens barrel 2 extend in different directions from the A-axis and the B-axis, as shown in FIG. 8. Specifically, C-axis as the first control axis that passes the support point defined by the ball bearing 71, and D-axis as the second control axis that passes the support point and extends in a direction different from the C-axis on a plane perpendicular to the optical axis of the lens barrel 2 are defined as the anti-shake axes.

The C-axis is an axis connecting a mid point between the position on the A-axis where the first actuator 31A is provided and the position on the B-axis where the second actuator 31B is provided, and the support point. The D-axis is an axis which passes the support point, and extends parallel to a line connecting the position on the A-axis where the first actuator 31A is provided and the position on the B-axis where the second actuator 31B is provided. Thus, the C-axis and the D-axis are defined as the anti-shake axes by angularly displacing the shake detection axes of the pitch gyro sensor 11 and the yaw gyro sensor 12 i.e. the A-axis and the B-axis by about 45 degrees about the support point, respectively so that the lens barrel 2 is driven about the C-axis and the D-axis for anti-shake control. Angular signals θC and θD about the C-axis and the D-axis for anti-shake control are obtained by the shake amount detecting circuit 142 (see FIG. 3) based on gyro signals i.e. angular velocity signals about the A-axis and the B-axis, which have been detected by the pitch gyro sensor 11 and the yaw gyro sensor 12.

The first actuator 31A and the second actuator 31B are so constructed as to rotate the lens barrel 2 about the C-axis and the D-axis by controlling the first actuator 31A and the second actuator 31B in such a manner that anti-shake driving forces about the A-axis and B-axis are simultaneously exerted to the lens barrel 2. Specifically, in the case where the angular signals θC and θD about the C-axis and the D-axis are acquired, as shown in FIG. 8, positioning target values for the first actuator 31A and the second actuator 31B are expressed by the following equations (3) through (6), assuming that the distances between the first actuator 31A and the C-axis, and between the second actuator 31B and the C-axis are defined as IAC and IBC, and the distances between the first actuator 31A and the D-axis, and between the second actuator 31B and the D-axis are defined as IAD and IBD. The positioning target values are obtained by the coefficient converting circuit 143.

In control about C-axis:
target value (trg) for first actuator=IAC×θC (3)
target value (trg) for second actuator=−IBC×θC (4)

In control about D-axis:
target value (trg) for first actuator=IAD×θD (5)
target value (trg) for second actuator=IBD×θD (6)
where the minus sign on the right side of the equation (4) represents reverse phase.

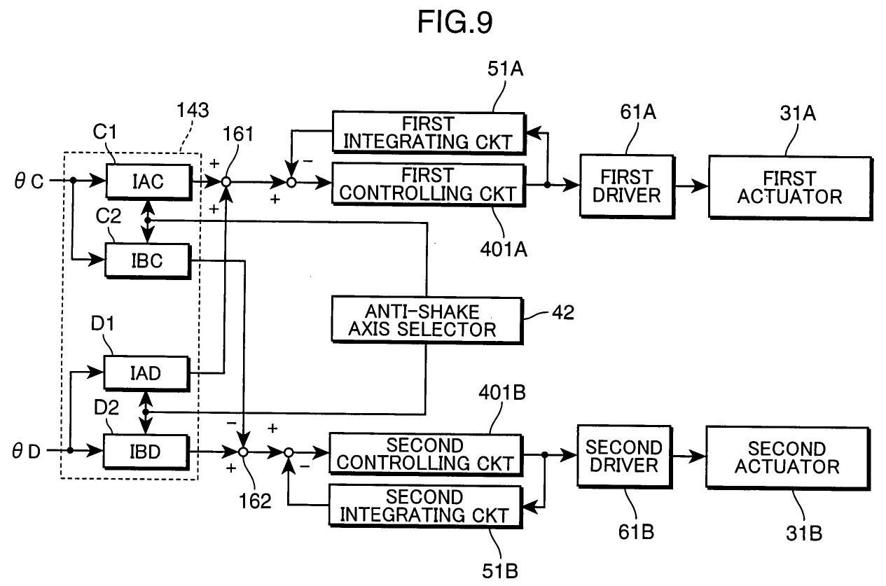

FIG. 9 is an illustration showing a control block diagram of the anti-shake mechanism E1. The first actuator 31A is controlled by a first controlling circuit 401A by way of a first driver 61A. The current position information of the first actuator 31A is obtained by a first integrating circuit 51A, where the drive pulse number sent from the first controlling circuit 401A to the first driver 61A is integrated. The first controlling circuit 401A, the first integrating circuit 51A, and the first driver 61A correspond to the controlling circuit 4, the integrating circuit 5, and the driving circuit 6 described referring to FIG. 3, respectively, and description thereof is omitted herein to avoid repeated description. Similarly, the second actuator 31B is controlled by a second controlling circuit 401B by way of a second driver 61B, and the current position information of the second actuator 31B is obtained by a second integrating circuit 51B. Similarly to the above arrangement, the second controlling circuit 401B, since the second integrating circuit 51B, and the second driver 61B correspond to the controlling circuit 4, the integrating circuit 5, and the driving circuit 6 described referring to FIG. 3, respectively, description thereof is omitted herein to avoid repeated description.

The coefficient converting circuit 143 generates an anti-shake control signal C1 (=IAC×θC) for controlling the first actuator 31A to drive the lens barrel 2 about the C-axis, and an anti-shake control signal C2 (=IBC×θC) for controlling the second actuator 31B to drive the lens barrel 2 about the D-axis, using the angular signal θC indicative of rotation about the C-axis. Likewise, the coefficient converting circuit 143 generates an anti-shake control signal D1 (=IAD×θD) for controlling the first actuator 31A to drive the lens barrel 2 about the D-axis, and an anti-shake control signal D2 (=IBD×θD) for controlling the second actuator 31B to drive the lens barrel 2 about the D-axis, using the angular signal θD indicative of rotation about the D-axis.

The anti-shake axis selector 42 performs a switching operation between anti-shake control about the C-axis, and anti-shake control about the D-axis within one sampling interval. Specifically, the anti-shake axis selector 42 outputs the anti-shake control signal C1 to the first controlling circuit 401A, and the anti-shake control signal C2 to the second controlling circuit 401B in response to selecting the anti-shake control about the C-axis, and outputs the anti-shake control signal D1 to the first controlling circuit 401A, and the anti-shake control signal D2 to the second controlling circuit 401B in response to selecting the anti-shake control about the D-axis.

The anti-shake control signals pass through polarity converters 161, 162 before being outputted to the first controlling circuit 401A and the second controlling circuit 401B, respectively. The signs “+”, “−” attached to the polarity converters 161, 162 indicate positive polarity and negative polarity, respectively. In the case of the control block diagram shown in FIG. 9, the anti-shake control signal C2 (=IBC×θC) is outputted to the second controlling circuit 401B as a signal having a negative polarity, whereas the anti-shake control signals C1 and D1 are outputted to the first controlling circuit 401A, and the anti-shake control signal D2 is outputted to the second controlling circuit 401B, as signals having positive polarities. This means that the second actuator 31B is driven with a phase opposite to the phase of the first actuator 31A in the anti-shake control about the C-axis, and that the first actuator 31A and the second actuator 31B are driven with phases identical to each other in the anti-shake control about the D-axis.

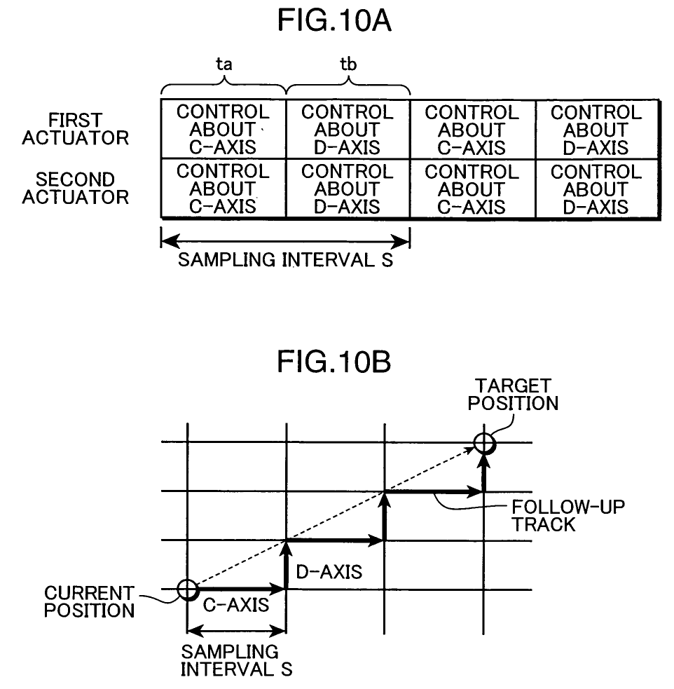

FIG. 10A is a time chart showing control operations to be executed by the anti-shake mechanism E1 shown in FIG. 9 at each sampling interval S. As shown in FIG. 10A, one sampling interval S is time-shared by a former half period ta, and a latter half period tb. In the former half period ta, the anti-shake axis selector 42 selects the anti-shake control about the C-axis as the first control axis, so that the anti-shake control signals C1 and C2 as first anti-shake drive signals are outputted to the first actuator 31A and to the second actuator 31B, respectively. Thereby, the anti-shake driving of the lens barrel 2 about the C-axis is executed by cooperative driving of the first actuator 31A and the second actuator 31B. Subsequently, in the latter half period tb, the anti-shake axis selector 42 selects the anti-shake control about the D-axis as the second control axis, so that the anti-shake control signals D1 and D2 as second anti-shake drive signals are outputted to the first actuator 31A and to the second actuator 31B, respectively. Thereby, the anti-shake driving of the lens barrel 2 about the D-axis is executed by cooperative driving of the first actuator 31A and the second actuator 31B.

FIG. 10B is an illustration showing a relation between target position, and follow-up track in anti-shake driving. As shown in FIG. 10B, in the case where a target position is set relative to the current position, the anti-shake driving of the lens barrel 2 about the C-axis, and the anti-shake driving of the lens barrel 2 about the D-axis are sequentially executed within each sampling interval S, whereby the follow-up track has a stepwise configuration toward the target position. Thereby, the anti-shake driving about the C-axis, and the anti-shake driving about the D-axis are each executed by cooperative driving of the first actuator 31A and the second actuator 31B. This is significantly different from the conventional anti-shake driving as shown in FIG. 26.

Specifically, in the conventional anti-shake driving shown in FIG. 26, the first actuator 93A and the second actuator 93B are driven independently of each other for anti-shake driving about the A-axis and B-axis, respectively, without cooperation. In the driving control, there exists a certain target position at which driving of one of the actuators 93A and 93B is suspended. In view of this, it is necessary to design the actuators 93A and 93B in such a manner that a power i.e. a torque capable of driving the lens barrel 2 be generated singly by each actuator. On the other hand, in the first anti-shake mechanism E1, the C-axis and the D-axis obtained by angularly displacing the shake detection axes by about 45 degrees about the support point are defined as the anti-shake axes, and the sampling interval S is time-shared. This ensures to constantly drive both the first actuator 31A and the second actuator 31B within each sampling interval S, while eliminating likelihood that driving of either one of the first actuator 31A and the second actuator 31B may be suspended, which contributes to miniaturization of the stepping motor to be used as the first actuator 31A and the second actuator 31B.

In other words, a torque NC to be generated by driving of the first actuator 31A and the second actuator 31B about the C-axis, and a torque to be generated by driving of the first actuator 31A and the second actuator 31B about the D-axis are expressed by the equations (7), (8), assuming that thrusts of the first actuator 31A and the second actuator 31B are defined as FA, FB, respectively.
NC=IAC×FA+IBC×FB (7)
ND=IAD×FA+IBD×FB (8)

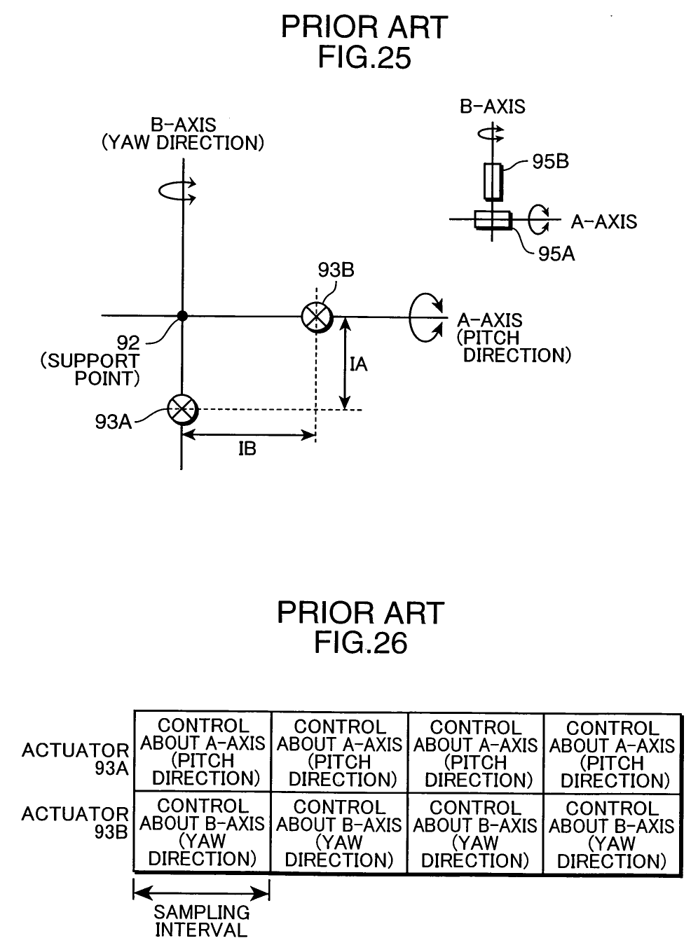

Assuming that IA=IB=IAC=IAD=IBC=IBD concerning the relation between IA and IB shown in FIG. 25 and used in the equations (1), (2), and assuming that thrusts of the first and second actuators 31A and 31B are identical to each other, the following relation is established.
NC=2NA
ND=2NB

This means that the anti-shake mechanism, E1 is capable of generating the torques NC, ND twice as large as the torques in the conventional arrangement.

In this way, the load to the stepping motors individually used as the first actuator 31A and the second actuator 31B can be reduced, which makes it possible to adopt a compact stepping motor. Also, even in a case that a stepping motor of the substantially same size as in the conventional arrangement is used, the above arrangement enables to generate a larger torque, as compared with the conventional arrangement, thereby lowering a required current value. This arrangement is advantageous in suppressing an influence of cogging torque, reducing vibration or noise of the stepping motor, and increasing precision in positioning for micro-step driving, thereby providing improved anti-shake performance.

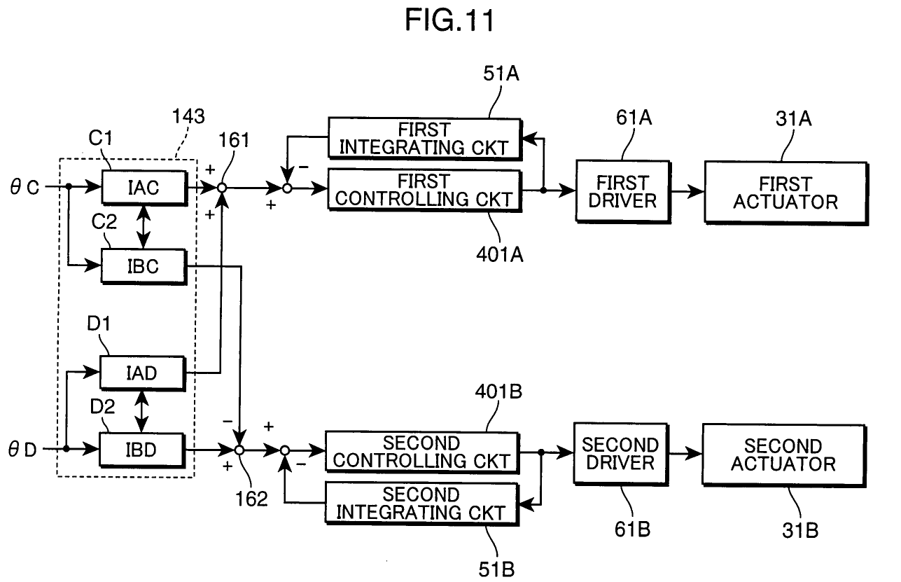

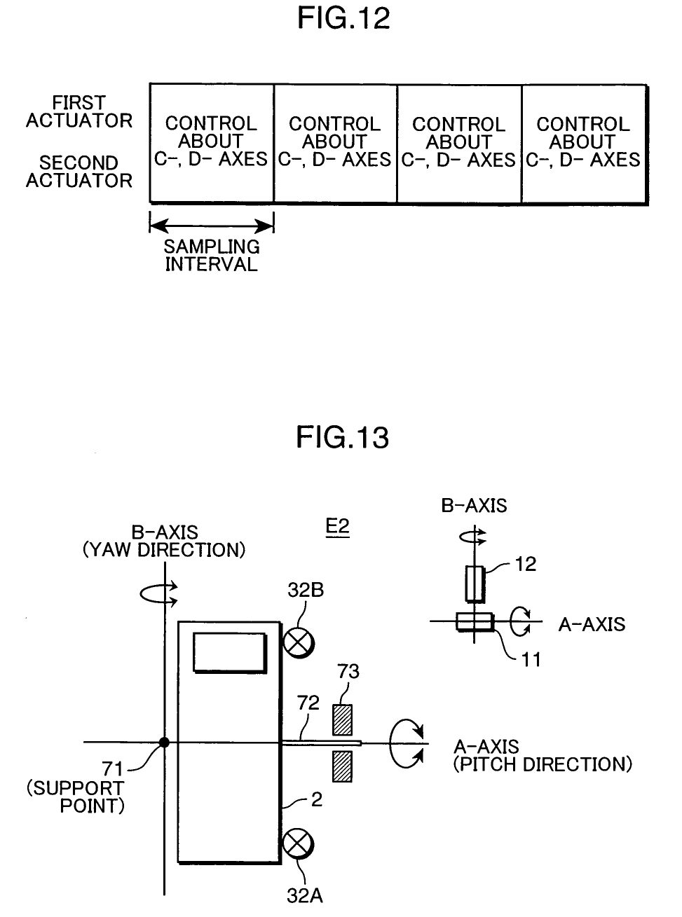

In the first anti-shake mechanism E1, it is possible to provide a control arrangement without the anti-shake axis selector 42. FIG. 11 is a control block diagram showing a modified arrangement without the anti-shake axis selector 42. Elements in FIG. 11 which are equivalent or identical to those in FIG. 9 are denoted at the like reference numerals. The modification is substantially the same as the first anti-shake mechanism in that anti-shake driving about the C-axis and anti-shake driving about the D-axis are executed by cooperative driving of a first actuator 31A and a second actuator 31B. Specifically, an anti-shake control signal C1 (=IAC×θC) about the C-axis, and an anti-shake control signal D1 (=IAD×θD) about the D-axis are outputted to a first controlling circuit 401A, and an anti-shake control signal C2 (=IBC×θC) about the C-axis and an anti-shake control signal D2 (=IBD×θD) about the D-axis are outputted to a second controlling circuit 401B to allow the first actuator 31A and the second actuator 31B to execute the anti-shake controls about the C-axis and the D-axis in cooperation with each other.

Specifically, positioning target values for the first actuator 31A and the second actuator 31B in the modification are expressed by the equations (9), (10).
target value (trg) for first actuator=IAC×θC+IAD×θD (9)
target value (trg) for second actuator=−IBC×θC+IBD×θD (10)

It should be noted, however, that there exists a target position at which driving of either one of the first and second actuators 31A, 31B may be suspended in the modification.

<Second Anti-Shake Mechanism>

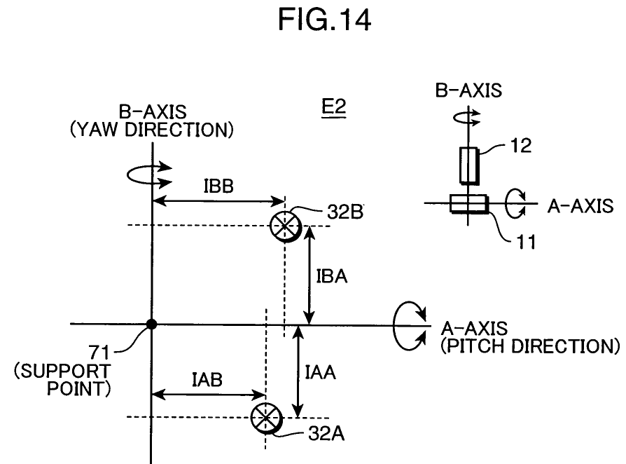

FIG. 13 is an illustration briefly showing an arrangement of a second anti-shake mechanism E2 in accordance with the embodiment. FIG. 14 is an illustration for describing a relation between anti-shake axes for a lens barrel and drive axes of actuators in the anti-shake mechanism E2. Similarly to the first anti-shake mechanism E1, the anti-shake mechanism E2 includes a lens barrel 2, a ball bearing 71 as a support member for supporting the lens barrel 2 at one point, a first actuator 32A and a second actuator 32B for applying anti-shake driving forces to the lens barrel 2 at positions different from each other, a guide pin 72, and a motion restrainer 73. Elements in the second anti-shake mechanism which are equivalent or identical to those in FIG. 6 are denoted as the same reference numerals.

The second anti-shake mechanism E2 is similar to the first anti-shake mechanism in that two actuators are used, but is different from the first anti-shake mechanism in that the first and second actuators 32A and 32B are arranged at different positions from the first and second actuators 31A and 31B in the first anti-shake mechanism. Specifically, both the first actuator 32A and the second actuator 32B are arranged on a side wall of the lens barrel 2 opposite to a side wall thereof where the ball bearing 71 is provided in contact therewith. The first actuator 32A is mounted at a lower position on the side wall, and the second actuator 32B is mounted at an upper position on the side wall.

In the anti-shake mechanism E2, shake detection axes of a pitch gyro sensor 11 and a yaw gyro sensor 12 i.e. A-axis and B-axis are made coincident with anti-shake axes for the lens barrel 2. Specifically, the anti-shake mechanism E2 is so constructed as to rotate the lens barrel 2 about the A-axis in pitch direction and about the B-axis in yaw direction for anti-shake control by controlling the first actuator 32A and the second actuator 32B in such a manner that anti-shake driving forces by the first and second actuators 32A and 32B are simultaneously exerted to the lens barrel 2. The drive axis along which the lens barrel 2 is driven by the first actuator 32A is an axis that passes the support point on a plane perpendicular to an incident optical axis of the lens barrel 2, and extends substantially orthogonal to a line connecting the support point and the point of application of force to the lens barrel 2 by the first actuator 32A. Also, the drive axis along which the lens barrel 2 is driven by the second actuator 32B is an axis that passes the support point on the above plane, and extends substantially orthogonal to a line connecting the support point and the point of application of force to the lens barrel 2 by the second actuator 32B. Thus, similarly to the first anti-shake mechanism, the anti-shake axes, i.e. the A-axis and the B-axis are obtained by angularly displacing the drive axes of the first and second actuators 32A and 32B by about 45 degrees about the support point. In other words, the anti-shake mechanism E2 provides a relation equivalent to the relation shown in FIG. 8 between the anti-shake axes i.e. the C-axis and the D-axis, and the drive axes i.e. A-axis and B-axis by arranging the first and second actuators 32A and 32B at the positions as shown in FIG. 13.

Positioning target values in the anti-shake mechanism E2 are defined as follows. Specifically, in the case where angular signals θA and θB about the A-axis and the B-axis are acquired, as shown in FIG. 14, positioning target values for the first actuator 32A and the second actuator 32B are expressed by the following equations (11) through (14), assuming that the distances between the first actuator 32A and the A-axis, and between the second actuator 32B and the A-axis are defined as IAA and IBA, and the distances between the first actuator 32A and the B-axis, and between the second actuator 32B and the B-axis are defined as IAB and IBB. The positioning target values are obtained by a coefficient converting circuit 143.

In control about A-axis:
target value (trg) for first actuator=IAA×θA (11)
target value (trg) for second actuator=−IBA×θA (12)

In control about B-axis:
target value (trg) for first actuator=IAB×θB (13)
target value (trg) for second actuator=IBB×θB (14)

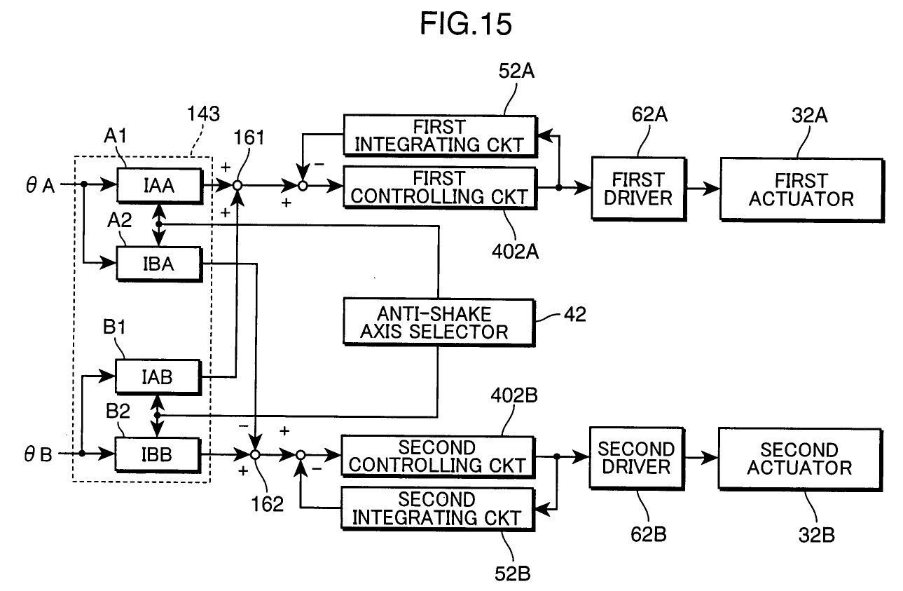

FIG. 15 is an illustration showing a control block diagram of the anti-shake mechanism E2. The first actuator 32A is controlled by a first controlling circuit 402A by way of a first driver 62A. The current position information of the first actuator 32A is obtained by a first integrating circuit 52A, where the drive pulse number sent from the first controlling circuit 402A to the first driver 62A is integrated. Likewise, the second actuator 32B is controlled by a second controlling circuit 402B by way of a second driver 62B, and the current position information of the second actuator 32B is obtained by a second integrating circuit 52B.

The coefficient converting circuit 143 generates an anti-shake control signal A1 (=IAA×θA) for controlling the first actuator 32A to drive the lens barrel 2 about the A-axis, and an anti-shake control signal A2 (=IBA×θA) for controlling the second actuator 32B to drive the lens barrel 2 about the A-axis, using the angular signal θA indicative of rotation about the A-axis. Likewise, the coefficient converting circuit 143 generates an anti-shake control signal B1 (=IAB×θB) for controlling the first actuator 32A to drive the lens barrel 2 about the B-axis, and an anti-shake control signal B2 (=IBB×θB) for controlling the second actuator 32B to drive the lens barrel 2 about the B-axis, using the angular signal θB indicative of rotation about the B-axis.

An anti-shake axis selector 42 performs a switching operation between anti-shake control about the A-axis, and anti-shake control about the B-axis within one sampling interval. Specifically, the anti-shake axis selector 42 outputs the anti-shake control signal A1 to the first controlling circuit 402A, and the anti-shake control signal A2 to the second controlling circuit 402B in response to selecting the anti-shake control about the A-axis, and outputs the anti-shake control signal B1 to the first controlling circuit 402A, and the anti-shake control signal B2 to the second controlling circuit 402B in response to selecting the anti-shake control about the B-axis.

Operations of polarity converters 161, 162 in the second anti-shake mechanism are the same as those in the first anti-shake mechanism. In the case of the control block diagram shown in FIG. 15, the anti-shake control signal A2 (=IBA×θA) is outputted to the second controlling circuit 402B as a signal having a negative polarity, whereas the anti-shake control signals A1 and B1 are outputted to the first controlling circuit 402A, and the anti-shake control signal B2 is outputted to the second controlling circuit 402B, as signals having positive polarities. This means that the second actuator 32B is driven with a phase opposite to the phase of the first actuator 32A in the anti-shake control about the A-axis, and that the first actuator 32A and the second actuator 32B are driven with phases identical to each other in the anti-shake control about the B-axis.

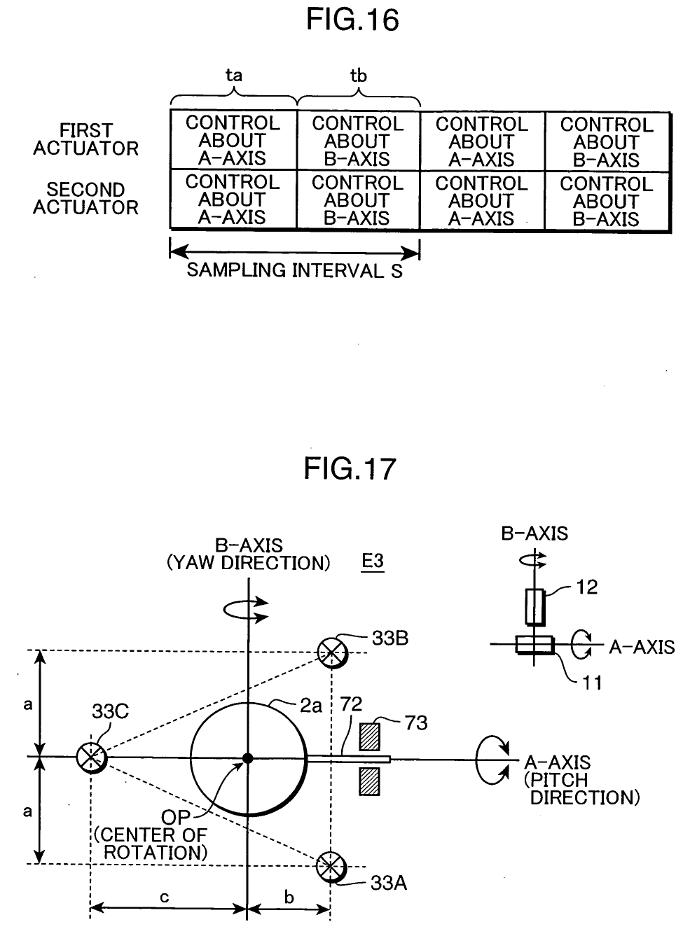

FIG. 16 is a time chart showing control operations to be executed by the anti-shake mechanism E2 shown in FIG. 15 at each sampling interval S. As shown in FIG. 16, one sampling interval S is time-shared by a former half period ta, and a latter half period tb. In the former half period ta, the anti-shake axis selector 42 selects the anti-shake control about the A-axis as the first control axis, so that the anti-shake control signals A1 and A2 as first anti-shake drive signals are outputted to the first actuator 32A and to the second actuator 32B, respectively. Thereby, the anti-shake driving of the lens barrel 2 about the A-axis is executed by cooperative driving of the first actuator 32A and the second actuator 32B. Subsequently, in the latter half period tb, the anti-shake axis selector 42 selects the anti-shake control about the B-axis as the second control axis, so that the anti-shake control signals B1 and B2 as second anti-shake drive signals are outputted to the first actuator 32A and to the second actuator 32B, respectively. Thereby, the anti-shake driving of the lens barrel 2 about the B-axis is executed by cooperative driving of the first actuator 32A and the second actuator 32B.

<Third Anti-Shake Mechanism>

FIG. 17 is an illustration showing a schematic arrangement of a third anti-shake mechanism E3 in accordance with the embodiment, as well as a relation between anti-shake axes and drive axes of actuators. The anti-shake mechanism E3 is different from the first and second anti-shake mechanisms in that a lens barrel 2a as an imaging optical system is used as a driven member to be driven for anti-shake control, and that three actuators are provided. The third anti-shake mechanism is similar to the first and second anti-shake mechanisms in that a guide pin 72 and a motion restrainer 73 are used. The lens barrel 2a is a collapsible or non-collapsible lens barrel, which does not have the bent portion 202 as in the lens barrel 2 shown in FIG. 2, and is so constructed as to allow linear light incidence of a subject image.

Unlike the first and second anti-shake mechanisms where the lens barrel 2 is supported by the ball bearing 71, the anti-shake mechanism E3 is three-point supported by three actuators around the lens barrel 2a. Specifically, as shown in FIG. 17, the first actuator 33A, the second actuator 33B, and the third actuator 33C are arranged around the lens barrel 2a, which is a tubular member with an optical axis OP extending in a depthwise direction on the plane of FIG. 17. Each actuator is constituted of a stepping motor. Similarly to the arrangement described referring to FIG. 7, each actuator has a movable member 311 (not shown), and a pair of intervening pieces 205 (not shown) is arranged at an appropriate position on the outer surface of the lens barrel 2a as opposed to the counterpart movable member 311 of each actuator so that forward and backward movements of each movable member 311 are restrained by the corresponding intervening piece pair 205. For sake of simplifying the illustration, the first, second, and third actuators 33A, 33B, and 33C are depicted away from the outer surface of the lens barrel 2a. Actually, however, the first, second, and third actuators 33A, 33B, and 33C each has a point of application of force to act on a member (not shown) integral with the lens barrel 2a.

Here, the center of rotation i.e. center of rotation of the lens barrel 2a supported by the first, second, and third actuators 33A, 33B, and 33C, is defined on the optical axis OP. In other words, the center of anti-shake control is defined on the optical axis OP. This arrangement enables to perform anti-shake control about the optical axis OP, and eliminate an influence of parallel displacement arising from non-alignment of the optical axis OP, and the center of rotation i.e. the center of rotation of the driven member or the lens barrel, thereby securing anti-shake control with high precision.

In the anti-shake mechanism E3, shake detection axes of a pitch gyro sensor 11 and a yaw gyro sensor 12 i.e. A-axis and B-axis, and anti-shake axes for the lens barrel 2a are made coincident with each other. In other words, the lens barrel 2a is driven for anti-shake control about the A-axis in pitch direction and the B-axis in yaw direction by controlling at least two of the first through third actuators 33A through 33C in such a manner that anti-shake driving forces by the two actuators are simultaneously exerted to the lens barrel 2a.

In light of the fact that the center of rotation of the lens barrel 2a is defined on the optical axis OP, an axis that includes a certain point passing the optical axis OP of the lens barrel 2a on a plane perpendicular to the optical axis OP, and extends substantially orthogonal to a line connecting the certain point on the optical axis OP and the point of application of force to the lens barrel 2a by the first actuator 33A is defined as the drive axis of the first actuator 33A for driving the lens barrel 2a. Also, an axis that includes the certain point on the optical axis OP, and extends substantially orthogonal to a line connecting the point on the optical axis OP and the point of application of force to the lens barrel 2a by the second actuator 33B is defined as the drive axis of the second actuator 33B for driving the lens barrel 2a. The drive axis of the third actuator 33C for driving the lens barrel 2a coincides with the B-axis.

Positioning target values in the anti-shake mechanism E3 are defined as follows. Specifically, in the case where angular signals θA and θB about the A-axis and the B-axis are acquired, as shown in FIG. 17, positioning target values for the first actuator 33A, the second actuator 33B, and the third actuator 33C are expressed by the following equations (15) through (19), assuming that the distances between the first actuator 33A and the A-axis, and between the second actuator 33B and the A-axis are respectively defined as a, a, and the distances between the first actuator 33A and the B-axis, and between the second actuator 33B and the B-axis are respectively defined as b, b, and the distance between the third actuator 33C and the B-axis is defined as c. The positioning target values are obtained by a coefficient converting circuit 143.

In control about A-axis:
target value (trg) for first actuator=a×θA (15)
target value (trg) for second actuator=−a×θA (16)

In control about B-axis:
target value (trg) for first actuator=b×θB (17)
target value (trg) for second actuator=b×θB (18)
target value (trg) for third actuator=−c×θB (19)

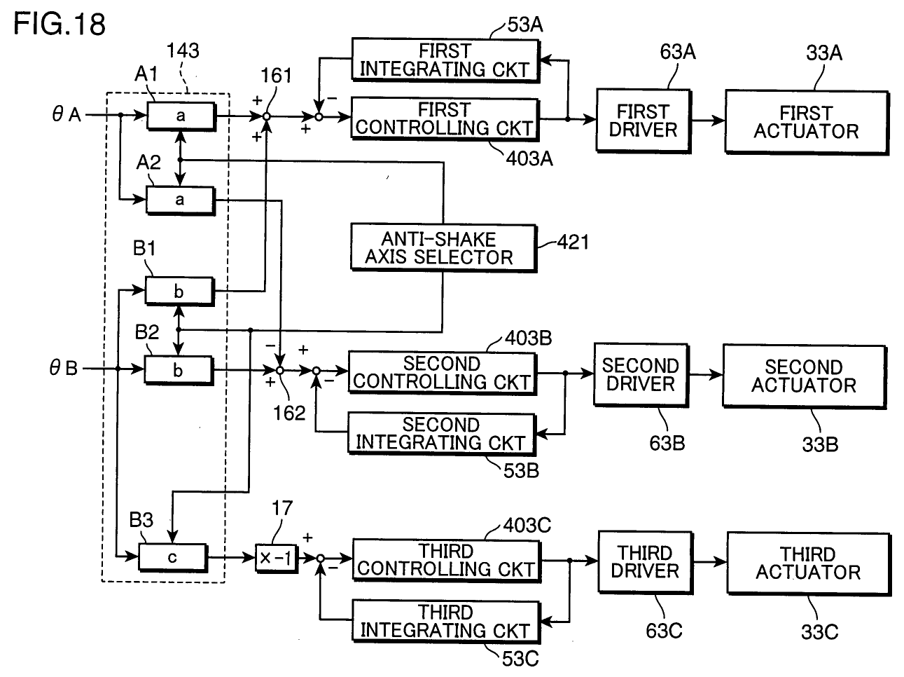

FIG. 18 is an illustration showing a control block diagram of the anti-shake mechanism E3. The first actuator 33A is controlled by a first controlling circuit 403A by way of a first driver 63A. The current position information of the first actuator 33A is obtained by a first integrating circuit 53A, where the drive pulse number sent from the first controlling circuit 403A to the first driver 63A is integrated. Likewise, the second actuator 33B is controlled by a second controlling circuit 403B by way of a second driver 63B, and the current position information of the second actuator 33B is obtained by a second integrating circuit 53B. Likewise, the third actuator 33C is controlled by a third controlling circuit 403C by way of a third driver 63C, and the current position information of the third actuator 33C is obtained by a third integrating circuit 53C.

The coefficient converting circuit 143 generates an anti-shake control signal A1 (=a×θA) for controlling the first actuator 33A to drive the lens barrel 2a about the A-axis, and an anti-shake control signal A2 (=a×θA) for controlling the second actuator 33B to drive the lens barrel 2a about the A-axis, using the angular signal θA indicative of rotation about the A-axis. Likewise, the coefficient converting circuit 143 generates an anti-shake control signal B1 (=b×θB) for controlling the first actuator 33A to drive the lens barrel 2a about the B-axis, an anti-shake control signal B2 (=b×θB) for controlling the second actuator 33B to drive the lens barrel 2a about the B-axis, and an anti-shake control signal B3 (=c×θB) for controlling the third actuator 33C to drive the lens barrel 2a about the B-axis, using the angular signal θB indicative of rotation about the B-axis.

An anti-shake axis selector 421 performs a switching operation between anti-shake control about the A-axis, and anti-shake control about the B-axis within one sampling interval. Specifically, the anti-shake axis selector 421 outputs the anti-shake control signal A1 to the first controlling circuit 403A, and the anti-shake control signal A2 to the second controlling circuit 403B in response to selecting the anti-shake control about the A-axis, and outputs the anti-shake control signal B1 to the first controlling circuit 403A, the anti-shake control signal B2 to the second controlling circuit 403B, and the anti-shake control signal B3 to the third controlling circuit 403C in response to selecting the anti-shake control about the B-axis.

In this anti-shake mechanism, three polarity converters 161, 162, and 17 are provided. In the case of the control block diagram shown in FIG. 18, the anti-shake control signal A2 (=a×θA) is outputted to the second controlling circuit 403B after polarity conversion into a negative polarity by the polarity converter 162, and the anti-shake control signal B3 (=c×θB) is outputted to the third controlling circuit 403C after polarity conversion into a negative polarity by the polarity converter 17. On the other hand, the anti-shake control signals A1 and B1 are outputted to the first controlling circuit 403A, and the anti-shake control signal B2 is outputted to the second controlling circuit 403B, as signals having positive polarities. This means that the second actuator 33B is driven with a phase opposite to the phase of the first actuator 33A in the anti-shake control about the A-axis, and that the first actuator 33A and the second actuator 33B are driven with phases identical to each other, and the third actuator 33C is driven with a phase opposite to the phases of the first actuator 33A and the second actuator 33B in the anti-shake control about the B-axis.

A time chart showing control operations to be executed by the anti-shake mechanism E3 at each sampling interval S is substantially similar to the time chart shown in FIG. 16 except for the following. Specifically, in the former half period ta for anti-shake control about the A-axis, driving of the third actuator 33C is suspended, and in the latter half period tb for anti-shake control about the B-axis, the third actuator 33C is driven for the anti-shake control about the B-axis.

<Fourth Anti-Shake Mechanism>

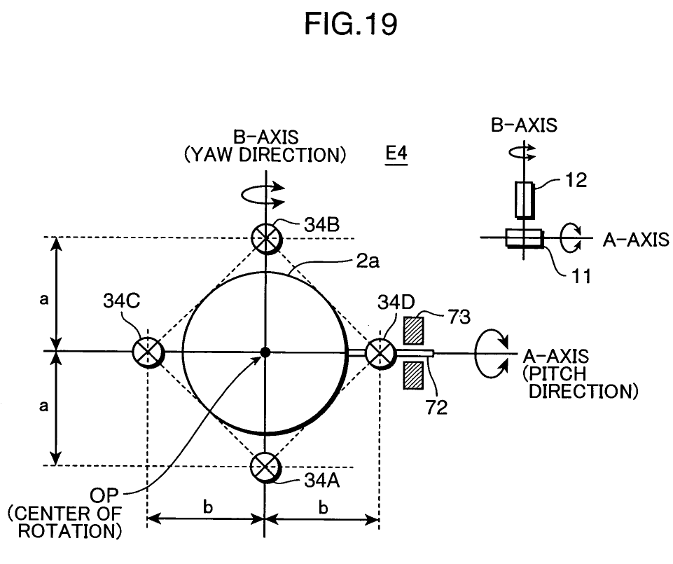

FIG. 19 is an illustration showing a schematic arrangement of a fourth anti-shake mechanism E4 in accordance with the embodiment, as well as a relation between anti-shake axes and drive axes of actuators. The anti-shake mechanism E4 is similar to the third anti-shake mechanism E3 in that a lens barrel 2a as an imaging optical system is used as a driven member to be driven for anti-shake control, but is different from the anti-shake mechanism E3 in that four actuators are used. A guide pin 72 and a motion restrainer 73 are provided as in the case of the third anti-shake mechanism.

Unlike the first and second anti-shake mechanisms where the lens barrel 2 is supported by the ball bearing 71, the anti-shake mechanism E4 is four-point supported by four actuators around the lens barrel 2a. Specifically, as shown in FIG. 19, the first actuator 34A, the second actuator 34B, the third actuator 34C, and the fourth actuator 34D are arranged around the lens barrel 2a, which is a tubular member with an optical axis OP extending in a depthwise direction on the plane of FIG. 19. Each actuator is constituted of a stepping motor. Similarly to the arrangement described referring to FIG. 7, each actuator has a movable member 311 (not shown), and a pair of intervening pieces 205 (not shown) is arranged at an appropriate position on the outer surface of the lens barrel 2a as opposed to the counterpart movable member 311 of each actuator so that forward and backward movements of each movable member 311 are restrained by the corresponding intervening piece pair 205. For sake of simplifying the illustration, the first through fourth actuators 34A through 34D are depicted away from the outer surface of the lens barrel 2a. Actually, however, the first through fourth actuators 34A through 34D each has a point of application of force to act on a member (not shown) integral with the lens barrel 2a. Similarly to the third anti-shake mechanism, the center of rotation i.e. the center of rotation of the lens barrel 2a supported by the first through fourth actuators 34A through 34D, is defined on the optical axis OP. In other words, the center of anti-shake control is defined on the optical axis OR This arrangement enables to perform anti-shake control about the optical axis OP with high precision.

In the anti-shake mechanism E4, shake detection axes of a pitch gyro sensor 11 and a yaw gyro sensor 12 i.e. A-axis and B-axis, and anti-shake axes for the lens barrel 2a are made coincident with each other. In other words, the lens barrel 2a is driven for anti-shake control about the A-axis in pitch direction and the B-axis in yaw direction by controlling at least two of the first through fourth actuators 34A through 34D in such a manner that anti-shake driving forces by the two actuators are simultaneously exerted to the lens barrel 2a.

In light of the fact that the center of rotation of the lens barrel 2a is defined on the optical axis OP, and the four actuators 34A through 34D are arranged equidistantly away from each other around the lens barrel 2a by 90 degrees in a state that the first and second actuators 34A and 34B are arranged on the B-axis, and the third and fourth actuators 34C and 34D are arranged on the A-axis, the drive axes along which the lens barrel 2a is driven by the first actuator 34A and the second actuator 34B are coincident with the A-axis. In other words, an axis that includes a certain point passing the optical axis OP of the lens barrel 2a on a plane perpendicular to the optical axis OP, and extends substantially orthogonal to a line connecting the certain point on the optical axis OP and the points of application of force to the lens barrel 2a by the first actuator 34A and the second actuator 34B is defined as the drive axes of the first and second actuators 34A and 34B. Also, the drive axes of the third actuator 34C and the fourth actuator 34D are coincident with the B-axis. In other words, an axis that includes the point on the optical axis OP, and extends substantially orthogonal to a line connecting the point on the optical axis OP and the points of application of force to the lens barrel 2a by the third actuator 34C and the fourth actuator 34D is defined as the drive axes of the third and fourth actuators 34C and 34D.

Positioning target values in the anti-shake mechanism E4 are defined as follows. Specifically, in the case where angular signals θA and θB about the A-axis and the B-axis are acquired, as shown in FIG. 19, positioning target values for the first through fourth actuators 34A through 34D are expressed by the following equations (20) through (23), assuming that the distances between the first actuator 34A and the A-axis, and between the second actuator 34B and the A-axis are respectively defined as a, a, and the distances between the third actuator 34C and the B-axis, and between the fourth actuator 34D and the B-axis are respectively defined as b, b. The positioning target values are obtained by a coefficient converting circuit 143.

In control about A-axis:
target value (trg) for first actuator=a×θA (20)
target value (trg) for second actuator=−a×θA (21)

In control about B-axis:
target value (trg) for third actuator=−b×θB (22)
target value (trg) for fourth actuator=b×θB (23)

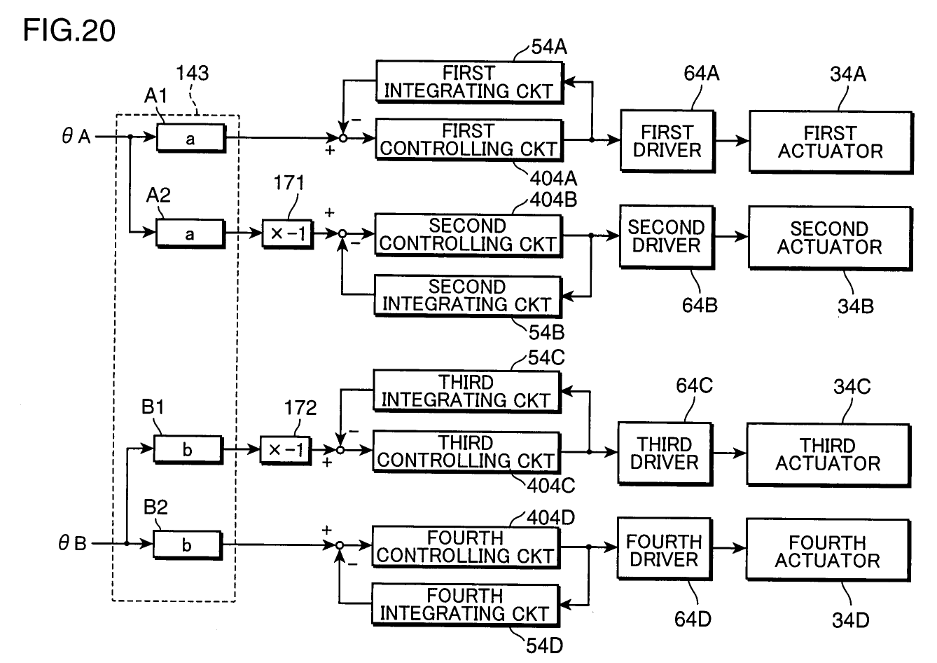

FIG. 20 is an illustration showing a control block diagram of the anti-shake mechanism E4. The first actuator 34A is controlled by a first controlling circuit 404A by way of a first driver 64A. The current position information of the first actuator 34A is obtained by a first integrating circuit 54A, where the drive pulse number sent from the first controlling circuit 404A to the first driver 64A is integrated. Likewise, the second actuator 34B is controlled by a second controlling circuit 404B by way of a second driver 64B, and the current position information of the second actuator 34B is obtained by a second integrating circuit 54B. Likewise, the third actuator 34C is controlled by a third controlling circuit 404C by way of a third driver 64C, and the current position information of the third actuator 34C is obtained by a third integrating circuit 54C. Also, the fourth actuator 34D is controlled by a fourth controlling circuit 404D by way of a fourth driver 64D, and the current position information of the fourth actuator 34D is obtained by a fourth integrating circuit 54D.

The coefficient converting circuit 143 generates an anti-shake control signal A1 (=a×θA) for controlling the first actuator 34A to drive the lens barrel 2a about the A-axis, and an anti-shake control signal A2 (=a×θA) for controlling the second actuator 34B to drive the lens barrel 2a about the A-axis, using the angular signal θA indicative of rotation about the A-axis. Likewise, the coefficient converting circuit 143 generates an anti-shake control signal B1 (=b×θB) for controlling the third actuator 34C to drive the lens barrel 2a about the B-axis, and an anti-shake control signal B2 (=b×θB) for controlling the fourth actuator 34D to drive the lens barrel 2a about the B-axis, using the angular signal θB indicative of rotation about the B-axis.

An anti-shake axis selector is not provided in the anti-shake mechanism E4. Accordingly, the anti-shake control signal A1 is outputted to the first controlling circuit 404A, and the anti-shake control signal A2 is outputted to the second controlling circuit 404B for anti-shake control about the A-axis. Also, the anti-shake control signal B1 is outputted to the third controlling circuit 404C, and the anti-shake control signal B2 is outputted to the fourth controlling circuit 404D for anti-shake control about the B-axis.

In this anti-shake mechanism, two polarity converters 171, 172 are provided. In the case of the control block diagram shown in FIG. 20, the anti-shake control signal A2 (=a×θA) is outputted to the second controlling circuit 404B after polarity conversion into a negative polarity by the polarity converter 171, and the anti-shake control signal B1 (=b×θB) is outputted to the third controlling circuit 404C after polarity conversion into a negative polarity by the polarity converter 172. On the other hand, the anti-shake control signal A1 is outputted to the first controlling circuit 404A, and the anti-shake control signal B2 is outputted to the fourth controlling circuit 404D, as signals having positive polarities, respectively. This means that the first actuator 34A and the second actuator 34B are driven with phases opposite to each other in the anti-shake control about the A-axis, and the third actuator 34C and the fourth actuator 34D are driven with phases opposite to each other in the anti-shake control about the B-axis.

In the anti-shake mechanism E4, the drive axes of the actuators for driving the lens barrel 2a, and the anti-shake axes for the lens barrel 2a are made coincident with each other. Also, a time chart showing control operations to be executed by the anti-shake mechanism E4 at each sampling interval S is similar to the time chart shown in FIG. 26 except for the following. Specifically, the relevant two actuators are driven in each of the anti-shake control about the A-axis and the anti-shake control about the B-axis. In other words, the anti-shake driving operations about the anti-shake axes are conducted by cooperative driving of the two relevant actuators. This reduces the load to the individual actuators in driving for anti-shake control, thereby leading to miniaturization of the actuators and energy saving.

<Fifth Anti-Shake Mechanism>

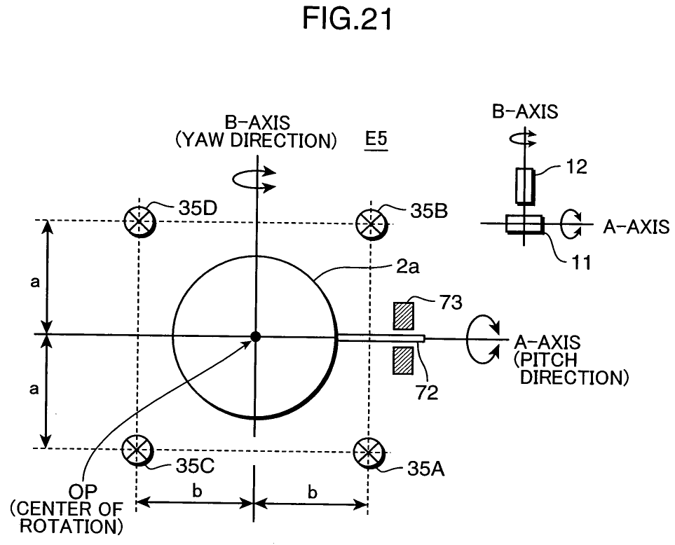

FIG. 21 is an illustration showing a schematic arrangement of a fifth anti-shake mechanism E5 in accordance with the embodiment, as well as a relation between anti-shake axes and drive axes of actuators. The anti-shake mechanism E5 is similar to the fourth anti-shake mechanism E4 in that a lens barrel 2a as an imaging optical system is driven for anti-shake control with use of four actuators, and that a guide pin 72 and a motion restrainer 73 are provided, but is different from the anti-shake mechanism E4 in that the drive axes of the actuators for driving the lens barrel 2a are defined in different directions from the anti-shake axes, and that two anti-shake axis selectors are provided.

Similarly to the fourth anti-shake mechanism, the fifth anti-shake mechanism E5 is four-point supported by four actuators around the lens barrel 2a. Specifically, as shown in FIG. 21, the first actuator 35A, the second actuator 35B, the third actuator 35C, and the fourth actuator 35D are arranged around the lens barrel 2a, which is a tubular member with an optical axis OP extending in a depthwise direction on the plane of FIG. 21. Each actuator is constituted of a stepping motor. Similarly to the arrangement described referring to FIG. 7, each actuator has a movable member 311 (not shown), and a pair of intervening pieces 205 (not shown) is arranged at an appropriate position on the outer surface of the lens barrel 2a as opposed to the counterpart movable member 311 of each actuator so that forward and backward movements of each movable member 311 are restrained by the corresponding intervening piece pair 205. For sake of simplifying the illustration, the first through fourth actuators 35A through 35D are depicted away from the outer surface of the lens barrel 2a. Actually, however, the first through fourth actuators 35A through 35D each has a point of application of force to act on a member (not shown) integral with the lens barrel 2a. Similarly to the third anti-shake mechanism, the center of rotation i.e. the center of rotation of the lens barrel 2a supported by the first through fourth actuators 35A through 35D, is defined on the optical axis OP. In other words, the center of anti-shake control is defined on the optical axis OP. This arrangement enables to perform anti-shake control about the optical axis OP with high precision.

Similarly to the fourth anti-shake mechanism, in the anti-shake mechanism E5, shake detection axes of a pitch gyro sensor 11 and a yaw gyro sensor 12 i.e. A-axis and B-axis, and anti-shake axes for the lens barrel 2a are made coincident with each other. In other words, the lens barrel 2a is driven for anti-shake control about the A-axis in pitch direction and the B-axis in yaw direction by controlling at least two of the first through fourth actuators 35A through 35D in such a manner that anti-shake driving forces by the two actuators are simultaneously exerted to the lens barrel 2a.

Similarly to the fourth anti-shake mechanism, the center of rotation of the lens barrel 2a is defined on the optical axis OP in the fifth anti-shake mechanism. However, the four actuators 35A through 35D are arranged around the lens barrel 2a with each of the actuators being angularly displaced from the A-axis and the B-axis by about 45 degrees about the center of rotation. Accordingly, an axis that includes a certain point passing the optical axis OP on a plane perpendicular to the optical axis OP, and extends substantially orthogonal to a line connecting the certain point on the optical axis OP and the point of application of force to the lens barrel 2a by the first actuator 35A is defined as the drive axis along which the lens barrel 2a is driven by the first actuator 35A. Also, an axis that includes the point on the optical axis OP, and extends substantially orthogonal to a line connecting the point on the optical axis OP and the point of application of force to the lens barrel 2a by the second actuator 35B is defined as the drive axis along which the lens barrel 2a is driven by the second actuator 35B. The drive axes of the third actuators 35C and the fourth actuator 35D are defined in the similar manner as mentioned above.

Positioning target values in the anti-shake mechanism E5 are defined as follows. Specifically, in the case where angular signals θA and θB about the A-axis and the B-axis are acquired, as shown in FIG. 21, positioning target values for the first through fourth actuators 35A through 35D are expressed by the following equations (24) through (31), assuming that the distances between the first actuator 35A and the A-axis, between the second actuator 35B and the A-axis, between the third actuator 35C and the A-axis, and between the fourth actuator 35D and the A-axis are respectively defined as a, a, a, a, and the distances between the first actuator 35A and the B-axis, between the second actuator 35B and the B-axis, between the third actuator 35C and the B-axis, and between the fourth actuator 35D and the B-axis are respectively defined as b, b, b, b. The positioning target values are obtained by a coefficient converting circuit 143.

In control about A-axis:
target value (trg) for first actuator=a×θA (24)
target value (trg) for second actuator=−a×θA (25)
target value (trg) for third actuator=a×θA (26)
target value (trg) for fourth actuator=−a×θA (27)

In control about B-axis:
target value (trg) for first actuator=b×θB (28)
target value (trg) for second actuator=b×θB (29)
target value (trg) for third actuator=−b×θB (30)
target value (trg) for fourth actuator=−b×θB (31)

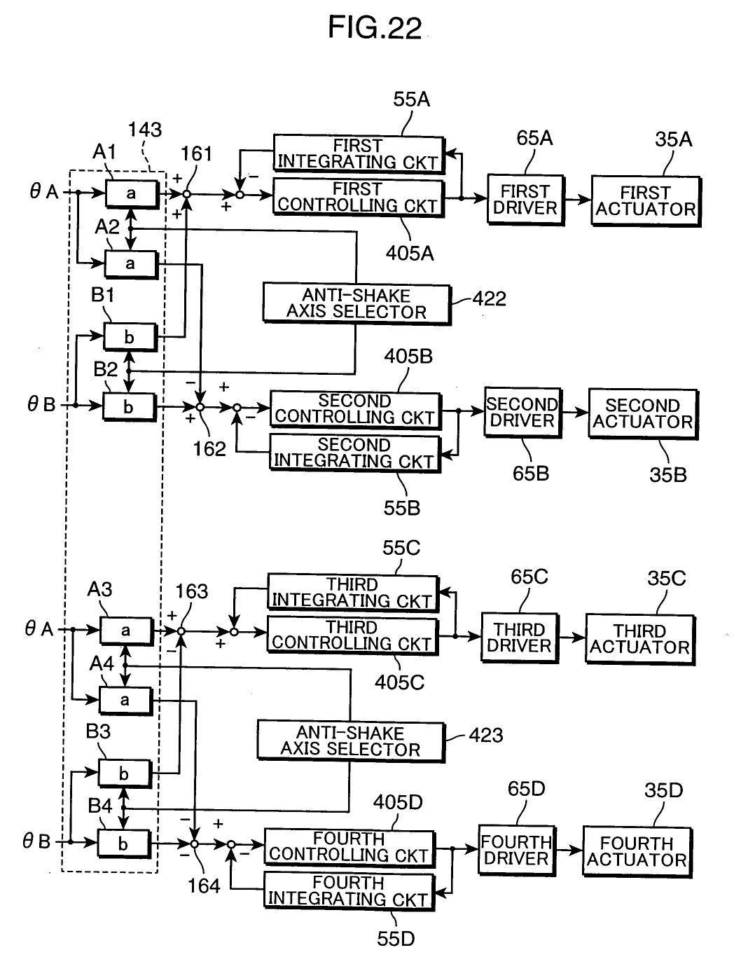

FIG. 22 is an illustration showing a control block diagram of the anti-shake mechanism E5. The first actuator 35A is controlled by a first controlling circuit 405A by way of a first driver 65A. The current position information of the first actuator 35A is obtained by a first integrating circuit 55A, where the drive pulse number sent from the first controlling circuit 405A to the first driver 65A is integrated. Likewise, the second actuator 35B is controlled by a second controlling circuit 405B by way of a second driver 65B, and the current position information of the second actuator 35B is obtained by a second integrating circuit 55B. Likewise, the third actuator 35C is controlled by a third controlling circuit 405C by way of a third driver 65C, and the current position information of the third actuator 35C is obtained by a third integrating circuit 55C. Also, the fourth actuator 35D is controlled by a fourth controlling circuit 405D by way of a fourth driver 65D, and the current position information of the fourth actuator 35D is obtained by a fourth integrating circuit 55D.

The coefficient converting circuit 143 generates anti-shake control signals A1 through A4 (=a×θA) for controlling the first through fourth actuators 35A through 35D to drive the lens barrel 2a about the A-axis, using the angular signal θA indicative of rotation about the A-axis. Likewise, the coefficient converting circuit 143 generates anti-shake control signals B1 through B4 (=b×θB) for controlling the first through fourth actuators 35A through 35D to drive the lens barrel 2a about the B-axis, using the angular signal θB indicative of rotation about the B-axis. The respective distances between the A-axis, and the first to fourth actuators 35A through 35D are the same i.e. the distance a, and the respective distances between the B-axis, and the first to fourth actuators 35A through 35D are the same i.e. the distance b. Accordingly, as far as the stepping motors identical to each other are used, the anti-shake control signals A1 through A4 for anti-shake control about the A-axis are identical to the anti-shake control signals B1 through B4 for anti-shake control about the B-axis, respectively.

In the anti-shake mechanism E5, two anti-shake axis selectors 422, 423 are provided. Each of the anti-shake axis selectors 422, 423 conducts a switching operation between the anti-shake control about the A-axis, and the anti-shake control about the B-axis in one sampling interval. Specifically, in response to selecting the anti-shake control about the A-axis, the anti-shake axis selector 422 is operative to output the anti-shake control signal A1 to the first controlling circuit 405A, and output the anti-shake control signal A2 to the second controlling circuit 405B. On the other hand, in response to selecting the anti-shake control about the B-axis, the anti-shake axis selector 422 is operative to output the anti-shake control signal B1 to the first controlling circuit 405A, and output the anti-shake control signal B2 to the second controlling circuit 405B. Likewise, in response to selecting the anti-shake control about the A-axis, the anti-shake axis selector 423 is operative to output the anti-shake control signal A3 to the third controlling circuit 405C, and output the anti-shake control signal A4 to the fourth controlling circuit 405D. On the other hand, in response to selecting the anti-shake control about the B-axis, the anti-shake axis selector 423 is operative to output the anti-shake control signal B3 to the third controlling circuit 405C, and output the anti-shake control signal B4 to the fourth controlling circuit 405D.

In this anti-shake mechanism, four polarity converters 161, 162, 163, and 164 are provided. In the case of the control block diagram shown in FIG. 22, the anti-shake control signals A2 (=a×θA) and A4 (=a×θA) are outputted to the second controlling circuit 405B and the fourth controlling circuit 405D after polarity conversion into negative polarities by the polarity converters 162 and 164, respectively. Also, the anti-shake control signals B3 (=b×θB) and B4 (=b×θB) are outputted to the third controlling circuit 405C and the fourth controlling circuit 405D after polarity conversion into negative polarities by the polarity converters 163 and 164, respectively. This means that the first actuator 35A and the third actuator 35C are driven with phases identical to each other, and the second actuator 35B and the fourth actuator 35D are driven with phases opposite to each other in the anti-shake control about the A-axis, and that the first actuator 35A and the second actuator 35B are driven with phases identical to each other, and the third actuator 35B and the fourth actuator 35D are driven with phases opposite to each other in the anti-shake control about the B-axis.

In the anti-shake mechanism E5, a time chart showing control operations to be executed by the anti-shake mechanism E5 at each sampling interval S is substantially the same as the time chart shown in FIG. 16. Specifically, referring to FIG. 16, one sampling interval S is time-shared by a former half period ta, and a latter half period tb. In the former half period ta, the anti-shake axis selectors 422, 423 are operative to select the anti-shake control about the A-axis as the first control axis, so that the anti-shake control signals A1 through A4 as first anti-shake drive signals are outputted to the first through fourth actuator 35A through 35D, respectively. Thereby, the anti-shake driving of the lens barrel 2a about the A-axis is executed by cooperative driving of the first through fourth actuators 35A through 35D.

Subsequently, in the latter half period tb, the anti-shake axis selectors 422, 423 are operative to select the anti-shake control about the B-axis as the second control axis, so that the anti-shake control signals B1 through B4 as second anti-shake drive signals are outputted to the first through fourth actuators 35A through 35D, respectively. Thereby, the anti-shake driving of the lens barrel 2a about the B-axis is executed by cooperative driving of the first through fourth actuators 35A through 35D.

<Sixth Anti-Shake Mechanism>

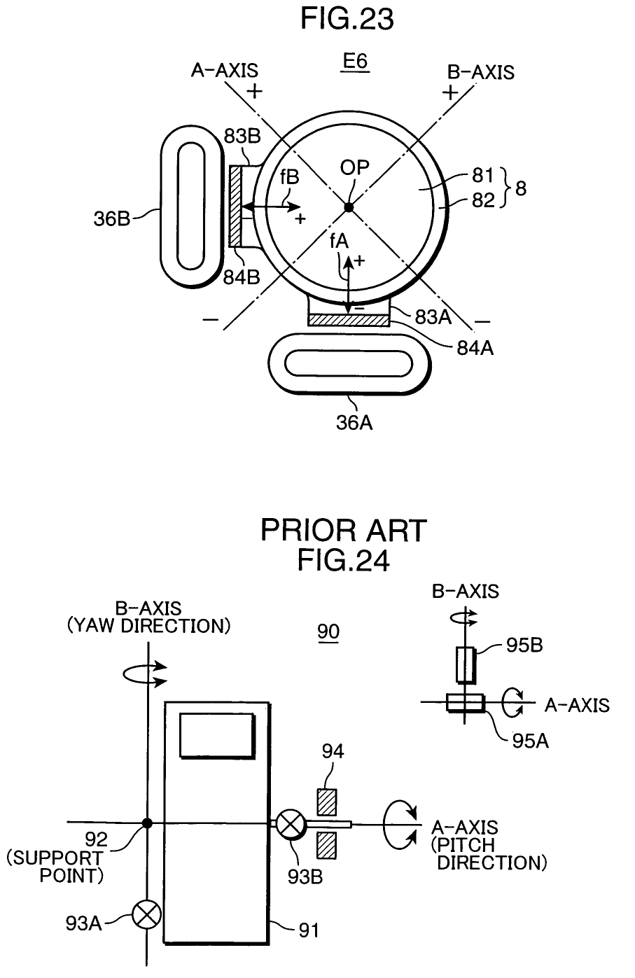

FIG. 23 is an illustration showing a schematic arrangement of a sixth anti-shake mechanism E6 in accordance with the embodiment. The anti-shake mechanism E6 has an anti-shake lens unit 8 produced by incorporating a driven member in an imaging optical system. The anti-shake mechanism E6 is operated in such a manner that the anti-shake lens unit 8 is linearly moved or shifted by actuators on a plane perpendicular to an optical axis OP of the anti-shake lens unit 8.

The anti-shake mechanism E6 includes the anti-shake lens unit 8, and a first actuator 36A and a second actuators 36B. The anti-shake lens unit 8 has an optical lens element 81 which is driven for anti-shake control, and a support frame 82 for supporting the optical lens element 81. The first and second actuators 36A, 36B each is constituted of a moving coil for shifting the anti-shake lens unit 8 on the plane perpendicular to the optical axis OP. A first base 83A having a surface for mounting a first magnet 84A thereon, and a second base 83B having a surface for mounting a second magnet 84B thereon are provided around the support frame 82, with the second base 83B being angularly displaced from the first base 83A by 90 degrees about a point on the optical axis OP where A-axis and B-axis intersect with each other. The first magnet 84A and the second magnet 84B are attached to the first base 83A and the second base 83B in such a manner that the first and second magnets 84A and 84B oppose the first and second actuators 36A and 36B each constituted of the moving coil, respectively.

A first control axis i.e. the A-axis, and a second control axis i.e. the B-axis orthogonal to the first control axis are defined for anti-shake driving of the ant-shake lens unit 8 on the plane perpendicular to the optical axis OP. Drive axes along which the anti-shake lens unit 8 is driven by the first and second actuators 36A and 36B are indicated by arrows fA and fB in FIG. 23, respectively. In other words, the A-axis and the B-axis as anti-shake axes, and the fa-axis and the fB-axis as drive axes of the actuators 36A and 36B extend in different directions from each other.

The anti-shake mechanism E6 is so constructed that the anti-shake lens unit 8 is linearly shifted in the A-axis direction or in the B-axis direction by applying anti-shake driving forces of the first and second actuators 36A and 36B to the anti-shake lens unit 8 by cooperative driving of the first and second actuators 36A and 36B. Specifically, anti-shake driving in the A-axis direction or in the B-axis direction by the first and second actuators 36A and 36B is executed in the following manner, assuming that the moving directions of the anti-shake lens unit 8 in the A-axis and the B-axis, and the fA-axis and the fB-axis are represented by the signs “+” and “−”.

In control of A-axis in +direction:

driving the first actuator 36A in +direction along the fA-axis

driving the second actuator 36B in −direction along the fB-axis

In control of A-axis in −direction:

driving the first actuator 36A in −direction along the fA-axis

driving the second actuator 36B in +direction along the fB-axis

In control of B-axis in +direction:

driving the first actuator 36A in +direction along the fA-axis

driving the second actuator 36B in +direction along the fB-axis

In control of B-axis in −direction:

driving the first actuator 36A in −direction along the fA-axis

driving the second actuator 36B in −direction along the fB-axis

In the anti-shake mechanism E6, the two actuators i.e. the first and second actuators 36A and 36B cooperatively shift or move the anti-shake lens unit 8 in the respective anti-shake axis directions for anti-shake control. This arrangement reduces the load to the individual actuators in executing the anti-shake driving. Generally, a moving coil, which is used as the actuator in the anti-shake mechanism, consumes a relatively large electric power, and the moving coil is energized in an inoperative state as well as in an operative state. However, in the anti-shake mechanism, the anti-shake driving in one anti-shake axis direction is executed by cooperative driving of the two moving coils. This arrangement enables to reduce the load to the individual moving coils, thereby reducing the space for the anti-shake mechanism, and providing improved energy saving effect.

In the foregoing, various image sensing apparatus equipped with an anti-shake mechanism are described. Various modifications may be applied to the invention. In the embodiments, a stepping motor or a moving coil is used as the actuator. Various types of actuators other than the stepping motor or the moving coil may be used, such as an impact-type piezoelectric actuator, wherein a movable member is linked to a rod-like vibrating member so that a certain frictional force is generated, and a piezoelectric element is fixed to one end of the vibrating member. In the embodiment, the digital still camera is described as an example of the image sensing apparatus. The invention may be applied to an image sensing apparatus such as a digital video camera.

As described above, an image sensing apparatus is equipped with an anti-shake mechanism. The apparatus comprises: a main body; an imaging optical system provided on the main body, the imaging optical system including a driven member; a shake detector for detecting a shake amount of the main body; a plurality of actuators each for applying an anti-shake driving force to the driven member at a different position from the other; and an anti-shake controller for generating an anti-shake drive signal to the respective actuators in accordance with a shake amount detected by the shake detector. A control axis about which the driven member is driven for anti-shake control extends in a direction different from a drive axis along which the driven member is driven for actual movement.

In this construction, the control axis for the anti-shake driving of the driven member, and the drive axis of the respective actuators for actually moving or shifting the driven member extend in the directions different from each other. Accordingly, there is no need of matching a load to be carried by the individual actuators with a load necessary for driving the driven member in the control axis direction for the anti-shake driving. In other words, it is possible to perform anti-shake driving in one control axis direction by the two actuators, for instance, which enables to reduce the load to the individual actuators, and provide improved latitude on actuator output designing. The above arrangement enables to increase latitude on the arrangement or the load of the actuator, widen the selection range on the type or the size of the actuator, and to miniaturize the actuator.

Preferably, the anti-shake controller may generate anti-shake drive signals to drive the respective actuators simultaneously. In this construction, the anti-shake drive signal is outputted to the respective actuators. This enables to perform the anti-shake driving of the driven member by cooperative driving of the actuators, thereby securing the anti-shake driving of the driven member even if the load performance of the individual actuators is low.

In the case where the control axis includes a first control axis and a second control axis extending in a direction different from the first control axis, the anti-shake controller may preferably generate, in a time-sharing manner, a first anti-shake drive signal for executing an anti-shake driving of the driven member in the first control axis direction, and a second anti-shake drive signal for executing an anti-shake driving of the driven member in the second control axis direction in a predetermined sampling interval.

In this construction, the first anti-shake drive signal and the second anti-shake drive signal are outputted to the respective actuators in a time-sharing manner. This enables to perform the anti-shake driving of the driven member in the first control axis direction and the second control axis direction, respectively, by cooperative driving of the actuators, which makes it possible to employ a compact actuator with a low load performance and a low power consumption. This leads to production of a compact and energy-saving-oriented image sensing apparatus.

The anti-shake driving in the first control axis direction and the anti-shake driving in the second control axis direction may be preferably cooperatively executed by at least two actuators, respectively. In this case, the apparatus may be further provided with an anti-shake control axis selector for outputting a first anti-shake drive signal to the at least two actuators so that the actuators execute the anti-shake driving in the first control axis direction, and outputting a second anti-shake drive signal to the at least two actuators so that the actuators execute the anti-shake driving in the second control axis direction.

In this construction, the anti-shake axis controller, at first, selects the first control axis as the control axis for the anti-shake driving, and outputs the first anti-shake drive signal to the at least two actuators, whereby the anti-shake driving in the first control axis direction is realized by cooperative driving of the actuators. Then, the anti-shake axis controller selects the second control axis as the control axis for the anti-shake driving, and outputs the second anti-shake drive signal to the at least two actuators, whereby the anti-shake driving in the second control axis direction is realized by cooperative driving of the actuators.

In the above construction, since the anti-shake axis selector is provided, the anti-shake driving by the at least two actuators can be performed smoothly and efficiently.

It may be preferable that the driven member includes a lens barrel, the lens barrel being supported at one point by a support member, and the actuators includes a first actuator and a second actuator for applying anti-shake driving forces to the lens barrel at different positions from each other, the control axis includes a first control axis and a second control axis for anti-shake driving of the lens barrel on a plane perpendicular to an optical axis of the lens barrel, the first control axis passing the support point of the lens barrel, and the second control axis passing the support point of the lens barrel and extending in a direction different from the first control axis, and the first actuator and the second actuator have the respective drive axes thereof extending in different directions from the first control axis direction and the second control axis direction, and apply respective anti-shake driving forces to the lens barrel along the respective drive axes to thereby rotate the lens barrel about the first control axis and the second control axis.

In this construction, the lens barrel is rotated for anti-shake control about the support point by cooperative driving of the two actuators both in the anti-shake driving about the first control axis and in the anti-shake driving about the second control axis. Since the lens barrel can be rotated for anti-shake control with a minimal number of the actuators, this arrangement contributes to production of a compact and energy-saving-oriented image sensing apparatus.

Preferably, it may be preferable that the driven member includes a lens barrel, the actuators includes at least three actuators for applying respective anti-shake driving forces to the lens barrel at at least three different positions from each other, the lens barrel being supported by the three actuators, the control axis includes a first control axis and a second control axis for anti-shake driving of the lens barrel on a plane perpendicular to an optical axis of the lens barrel, the first control axis passing the support point of the lens barrel, and the second control axis passing the support point of the lens barrel and extending in a direction different from the first control axis, and the at least three actuators respectively have drive axes extending in different directions from the first control axis direction and the second control axis direction, and apply the respective anti-shake driving forces in the respective drive axes to the lens barrel for rotating the lens barrel about the first control axis and the second control axis.

In this construction, the lens barrel is rotated for anti-shake control about the support point of the lens barrel i.e. the center of rotation of the lens barrel by cooperative driving of the at least two actuators among the at least three actuators. This arrangement enables to securely perform the anti-shake driving of the lens barrel with use of the at least three actuators.

A rotation support point or center of rotation of the lens barrel may be preferably defined as a center of the anti-shake control. In this construction, anti-shake control of the lens barrel free of positional displacement is secured. In other words, anti-shake control capable of canceling the shake amount of the image sensing apparatus can be securely performed.

A positioning target value for the actuator may be preferably obtained by multiplying a rotation angle about the first control axis or the second control axis by a distance between the first control axis or the second control axis, and a point of application of force of the actuator to the lens barrel.

In this construction, the positioning target value for the actuator in driving the lens barrel for anti-shake control can be obtained in a simplified manner, which enables to simplify the arrangement on a control circuit.

It may be preferable that the driven member is an anti-shake lens unit provided in the imaging optical system, the actuators includes at least two actuators for applying respective anti-shake driving forces to the anti-shake lens unit at different positions from each other, the control axis includes a first control axis and a second control axis for anti-shake driving of the anti-shake lens unit on a plane perpendicular to an optical axis of the imaging optical system, and the at least two actuators have respective drive axes extending in different directions from the first control axis direction and the second control axis direction, and apply respective anti-shake driving forces to the anti-shake lens unit by cooperative driving thereof for correctively moving the anti-shake lens unit in the first control axis direction or in the second control axis direction.

In this construction, the anti-shake lens unit can be shifted in the first control axis direction or the second control axis direction by cooperative driving of the at least two actuators in the anti-shake mechanism constructed such that the anti-shake lens unit is shifted on the plane perpendicular to the optical axis. This arrangement enables to provide a compact and energy-saving-oriented actuator in the anti-shake mechanism constructed such that the anti-shake lens unit is shifted on the plane perpendicular to the optical axis.

Also, an image sensing apparatus equipped with an anti-shake mechanism, comprises: a main body; an imaging optical system provided in the main body, the imaging optical system including a driven member; an anti-shake detector for detecting a shake amount of the main body; at least three actuators each for applying an anti-shake driving force to the driven member provided in the imaging optical system at different positions from each other; and an anti-shake controller for generating and sending an anti-shake drive signal to the respective actuators in accordance with a shake amount detected by the shake detector, the anti-shake controller controlling the at least two actuators to execute an anti-shake driving in one anti-shake axis direction in driving the driven member in a plurality of anti-shake axis directions for anti-shake control the anti-shake axis directions being different from each other.

In this construction, the anti-shake driving in the respective anti-shake axis directions can be executed by the at least two actuators. This enables to reduce the load to the individual actuators in performing the anti-shake driving, thereby leading to production of a compact and energy-saving-oriented actuator.

The actuator may preferably include a stepping motor. In this construction, positioning control for the anti-shake driving can be executed in an open-loop manner, which enables to eliminate a position detecting mechanism for the driven member. Also, the anti-shake driving in the one control axis direction for anti-shake control can be executed by cooperative driving of the plural actuators. This enables to use a compact stepping motor with a relatively small torque to be generated, thereby reducing the space for installing the actuators and reducing the production cost.

The actuator may preferably include a moving coil. Generally, a moving coil consumes a relatively large electric power because it is energized in an inoperative state as well as in an operative state. In this construction, however, the anti-shake driving in one control axis direction for anti-shake control can be executed by cooperative driving of the plural actuators. This enables to reduce a required load performance of the individual moving coils, thereby contributing to energy saving, which enables to provide an anti-shake-mechanism-equipped image sensing apparatus with less power consumption of a battery.

Furthermore, a method for performing an anti-shake control against an image sensing apparatus comprises the steps of detecting a shake amount of a main body of a image sensing apparatus provided with an imaging optical system; generating an anti-shake drive signal in accordance with a detected shake amount; sending the anti-shake drive signal to a plurality of actuators to apply an anti-shake driving force to a driven member provided in the imaging optical system at different positions from each other. A control axis about which the driven member is driven for anti-shake control extends in a direction different from a drive axis along which the driven member is driven for actual movement.

The control axis for the anti-shake driving and the drive axis of the actuators extend in the directions different from each other. Accordingly, it is possible to perform anti-shake driving in one control axis direction by the two actuators. This enables to reduce the load to the individual actuators, and provide improved latitude on actuator output designing.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image sensing apparatus equipped with an anti-shake mechanism, comprising:
a main body;
an imaging optical system provided on the main body, the imaging optical system including a driven member;
a shake detector for detecting a shake amount of the main body;
a plurality of actuators each for applying an anti-shake driving force to the driven member at a different position from the other; and
an anti-shake controller for generating an anti-shake drive signal to the respective actuators in accordance with a shake amount detected by the shake detector, wherein
a control axis about which the driven member is driven for anti-shake control extends in a direction different from a drive axis along which the driven member is driven for actual movement.

2. The image sensing apparatus according to claim 1, wherein
the anti-shake controller generates anti-shake drive signals to drive the respective actuators simultaneously.

3. The image sensing apparatus according to claim 1, wherein
in a condition that the control axis includes a first control axis and a second control axis extending in a direction different from the first control axis, the anti-shake controller generates, in a time-sharing manner, a first anti-shake drive signal for executing an anti-shake driving of the driven member in the first control axis direction, and a second anti-shake drive signal for executing an anti-shake driving of the driven member in the second control axis direction in a predetermined sampling interval.

4. The image sensing apparatus according to claim 3, wherein
the anti-shake driving in the first control axis direction and the anti-shake driving in the second control axis direction are cooperatively executed by at least two actuators, respectively, further comprising:
an anti-shake control axis selector for outputting a first anti-shake drive signal to the at least two actuators so that the actuators execute the anti-shake driving in the first control axis direction, and outputting a second anti-shake drive signal to the at least two actuators so that the actuators execute the anti-shake driving in the second control axis direction.

5. The image sensing apparatus according to claim 1, wherein
the driven member includes a lens barrel, the lens barrel being supported at one point by a support member, and the actuators includes a first actuator and a second actuator for applying anti-shake driving forces to the lens barrel at different positions from each other,
the control axis includes a first control axis and a second control axis for anti-shake driving of the lens barrel on a plane perpendicular to an optical axis of the lens barrel, the first control axis passing the support point of the lens barrel, and the second control axis passing the support point of the lens barrel and extending in a direction different from the first control axis, and
the first actuator and the second actuator have the respective drive axes thereof extending in different directions from the first control axis direction and the second control axis direction, and apply respective anti-shake driving forces to the lens barrel along the respective drive axes to thereby rotate the lens barrel about the first control axis and the second control axis.

6. The image sensing apparatus according to claim 5, wherein
a positioning target value for the actuator is obtained by multiplying a rotation angle about the first control axis or the second control axis by a distance between the first control axis or the second control axis, and a point of application of force of the actuator to the lens barrel.

7. The image sensing apparatus according to claim 1, wherein
the driven member includes a lens barrel,
the actuators includes at least three actuators for applying respective anti-shake driving forces to the lens barrel at at least three different positions from each other, the lens barrel being supported by the three actuators,
the control axis includes a first control axis and a second control axis for anti-shake driving of the lens barrel on a plane perpendicular to an optical axis of the lens barrel, the first control axis passing the support point of the lens barrel, and the second control axis passing the support point of the lens barrel and extending in a direction different from the first control axis, and
the at least three actuators respectively have drive axes extending in different directions from the first control axis direction and the second control axis direction, and apply the respective anti-shake driving forces in the respective drive axes to the lens barrel for rotating the lens barrel about the first control axis and the second control axis.

8. The image sensing apparatus according to claim 7, wherein
a rotation support point or center of rotation of the lens barrel is defined as a center of the anti-shake control.

9. The image sensing apparatus according to claim 7, wherein
a positioning target value for the actuator is obtained by multiplying a rotation angle about the first control axis or the second control axis by a distance between the first control axis or the second control axis, and a point of application of force of the actuator to the lens barrel.

10. The image sensing apparatus according to claim 1, wherein
the driven member is an anti-shake lens unit provided in the imaging optical system,
the actuators includes at least two actuators for applying respective anti-shake driving forces to the anti-shake lens unit at different positions from each other,
the control axis includes a first control axis and a second control axis for anti-shake driving of the anti-shake lens unit on a plane perpendicular to an optical axis of the imaging optical system, and
the at least two actuators have respective drive axes extending in different directions from the first control axis direction and the second control axis direction, and apply respective anti-shake driving forces to the anti-shake lens unit by cooperative driving thereof for correctively moving the anti-shake lens unit in the first control axis direction or in the second control axis direction.

11. The image sensing apparatus according to claim 1, wherein
the actuators each includes a stepping motor.

12. The image sensing apparatus according to claim 1, wherein
the actuators each includes a moving coil.

13. An image sensing apparatus equipped with an anti-shake mechanism, comprising:
a main body;
an imaging optical system provided in the main body, the imaging optical system including a driven member;
an anti-shake detector for detecting a shake amount of the main body;
at least three actuators each for applying an anti-shake driving force to the driven member provided in the imaging optical system at different positions from each other; and
an anti-shake controller for generating and sending an anti-shake drive signal to the respective actuators in accordance with a shake amount detected by the shake detector, the anti-shake controller controlling the at least two actuators to execute an anti-shake driving in one anti-shake axis direction in driving the driven member in a plurality of anti-shake axis directions for anti-shake control, the anti-shake axis directions being different from each other.

14. The image sensing apparatus according to claim 13, wherein
the actuators each includes a stepping motor.

15. The image sensing apparatus according to claim 13, wherein
the actuators each includes a moving coil.

16. A method for performing an anti-shake control against an image sensing apparatus, the method comprising the steps of
detecting a shake amount of a main body of a image sensing apparatus provided with an imaging optical system;
generating an anti-shake drive signal in accordance with a detected shake amount;
sending the anti-shake drive signal to a plurality of actuators to apply an anti-shake driving force to a driven member provided in the imaging optical system at different positions from each other;
wherein a control axis about which the driven member is driven for anti-shake control extends in a direction different from a drive axis along which the driven member is driven for actual movement.
